(19) United States
(12) Patent Application Publication
(10) Pub. No.: US 2006/0179463 A1
(43) Pub. Date: Aug. 10, 2006

(54) Remote surveillance

(76) Inventors: Alpin C. Chisholm, North Attleboro, MA (US); Phillip W. Gregory, Dunstable, MA (US); Jonathan A. Brown, Milton, MA (US); Paul J. Vanslette, Upton, MA (US)

Correspondence Address: FISH & RICHARDSON PC, P.O. BOX 1022, MINNEAPOLIS, MN, 55440-1022, US

(21) Appl. No.: 11/052,393

(22) Filed: Feb. 7, 2005

(51) Int. Cl. H04N 7/173

(52) U.S. Cl. 725/90; 725/86; 725/100; 725/131

(57) ABSTRACT

At a remote location, audio-visual data is received and processed to produce processed audio-visual data. The processed audio-visual data is communicated to a central location using a programmable logic controller communication protocol.

### BACKGROUND

This description relates to remote surveillance.

For water supplies, for example, concerns about security have prompted operators of the water supplies to improve their continuing observation of activities in the vicinity of water processing plants and water sources. One way that the surveillance can be done remotely is by communicating digital images from video cameras located at the site to a central location where the images can be monitored by an employee of the municipality.

Remote surveillance has been done or proposed using closed circuit television.

Surveillance equipment and software for use with Ethernet based process control networks is offered by Bristol Babcock under the brand name ControlWave Security Vision. An example of a remote video surveillance system is available from OzVision Hardware of Woburn, Mass.

### SUMMARY

In general, in one aspect, at a remote location, audio-visual data is received and processed to produce processed audio-visual data. The processed audio-visual data is communicated to a central location using a programmable logic controller communication protocol.

Implementations may include one or more of the following features. The audio-visual data includes video data. Communicating of the processed audio-visual data includes communicating non-protocol-compliant data encapsulated in protocol-compliant communications. The processed audio-visual data is communicated as live audio-visual on demand data, event-based audio-visual data, and/or continuous live audio-visual data. The audio-visual data includes at least one of audio data, still-image data, or video data. The communication protocol includes one or more of DF1, ROC native, Modbus, BSAP, and DF1 Radio Modem Protocol, DNP, UCA, IEC-61850, IEC-60870, GESNP, TIway, and Profibus-DP. Diagnostics are performed at the central location. The low bit rate is typically lower than 56K bits per second, for example, as low as 9600 bits per second. The low bit rate is also used for other communication by programmable logic controllers in low speed plant and wide-area monitoring and control networks.

A user is enabled to provide configuration parameters for the remote location using an online user interface. The configuration parameters are provided to the remote location using the programmable logic controller communication protocol. A mismatch may be detected between configuration parameters stored in a database at the central location and configuration parameters used at the remote location.

In general, in another aspect, at a central location, communications are received of processed audio-visual data generated at a remote location. The communications are received on a low-bandwidth communication channel using a programmable logic controller communication protocol.

In general, in another aspect, for use with a water supply or wastewater system (public or private), video data is produced for a field of view in a vicinity of at least a portion of the water supply or wastewater system. The video data is processed to produce processed audio-visual data. The processed video data is communicated to a central location using a low-bandwidth communication channel in accordance with a programmable logic controller communication protocol. At least a portion of the video data is made available to a user for monitoring the water supply or wastewater system.

In general, in another aspect, the processed audio-visual data is communicated to a central processor at a central location using a communication channel at a rate that is selectable to accommodate characteristics of the communication channel.

In general, in another aspect, an apparatus includes a local processor, one or more input ports to receive an input audio-visual data signal to be processed by the local processor, one or more ports to communicate processed audio-visual data and control information to a central processor located remotely from the local processor, and stored instructions to cause the local processor to act as a programmable logic controller with respect to communication with the central processor.

Implementations may include one or more of the following features. The processed audio-visual data is communicated on a low-bandwidth communication channel that is part of a low speed plant network. An audio-visual capture device produces the input audio-visual data signal.

In general, in another aspect, at a remote location, audio-visual data is received, an event is identified at the remote location, a brief segment of the audio-visual data associated with the event is stored, including audio-visual data that was received prior to the event, and the brief segment of the audio-visual data is communicated to a central processor at a central location.

Implementations may include one or more of the following features. Commands are communicated from the central location to the remote location with respect to the processed audio-visual data. The commands control the communicating of the processed audio-visual data to the central location. The commands control an audio-visual capture device at the remote location. The commands control a video camera to pan, tilt, or zoom. At the remote location, an event condition is determined based on the audio-visual data. Event conditions may also be determined based on other data obtained at the remote location, for example, intrusion detection devices such as motion detectors, door switches, and heat detectors. Event conditions may also be determined by software at the central location. An alarm may be triggered based on the event condition. The event condition can be based on analysis of images represented by the data. Event conditions may also be triggered by other PLC devices at the remote location. Characteristics are analyzed of at least one image of a field of view at the remote location represented by the audio-visual data, and the alarm condition is determined based on the audio-visual data and the analyzing. The analyzing includes color information. The analyzing includes intensity information. The commands include audio-visual parameters that are communicated in conformity with a programmable logic controller communication protocol. The processed audio-visual data can be a selected one or more of high quality video files, medium quality event clips, and low quality streaming video.

The remote location includes a location of a water or wastewater system. The remote location includes a location of a natural gas SCADA network. The remote location includes a location of a distributed monitoring and control network. The processed audio-visual data is provided to a user as part of a graphical user interface. The processed audio-visual data (except in the case of live video) is converted to AVI format for use in the graphical user interface.

In general, in another aspect, at a remote location, audio-visual data is received, an event is identified at the remote location based on the audio-visual data, and equipment is controlled at the remote location based on the event.

Other aspects may include software, systems, means for performing functions, and combinations of apparatus, systems, software, methods, and means based on one or more of the aspects and features recited above.

Other advantages and features will become apparent from the following description and from the claims.

### DESCRIPTION

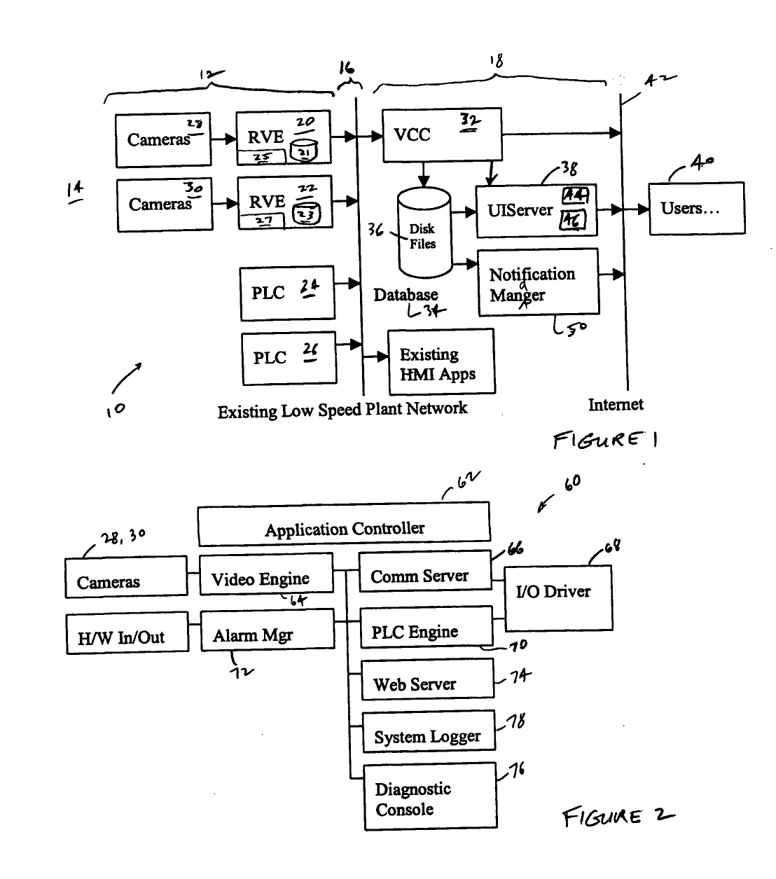

FIGS. 1 through 21 are block diagrams.

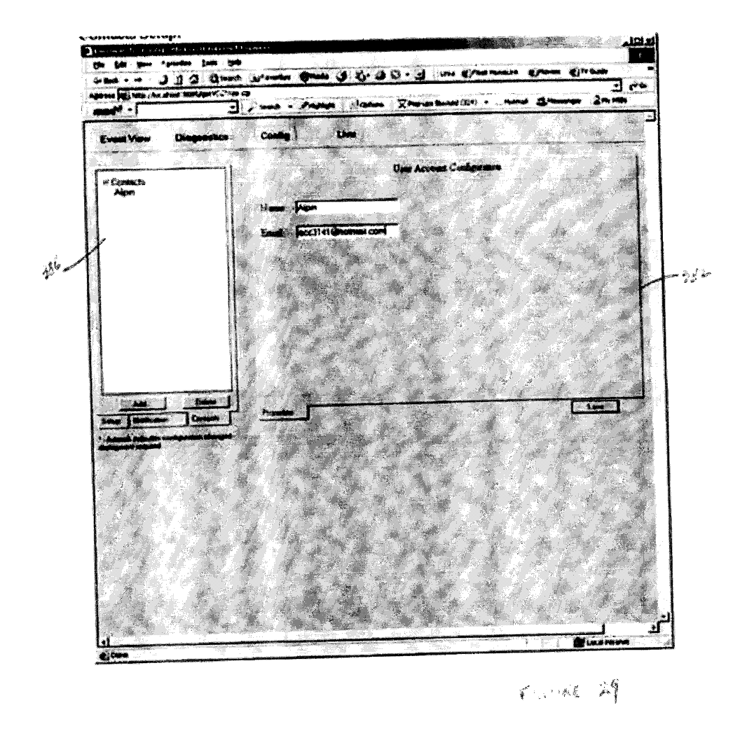

FIG. 22 illustrates an intensity range.

FIG. 23 illustrates a color range.

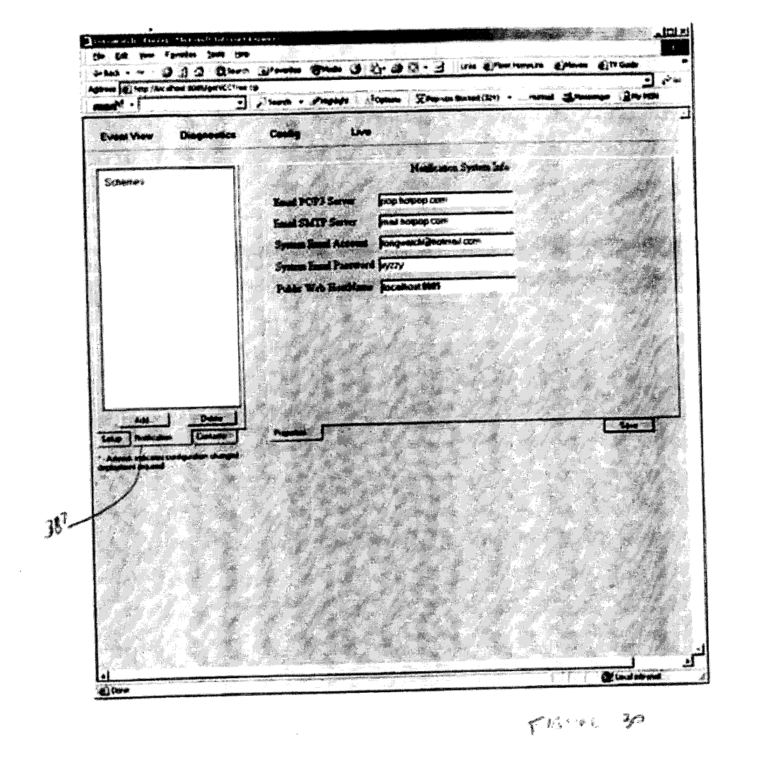

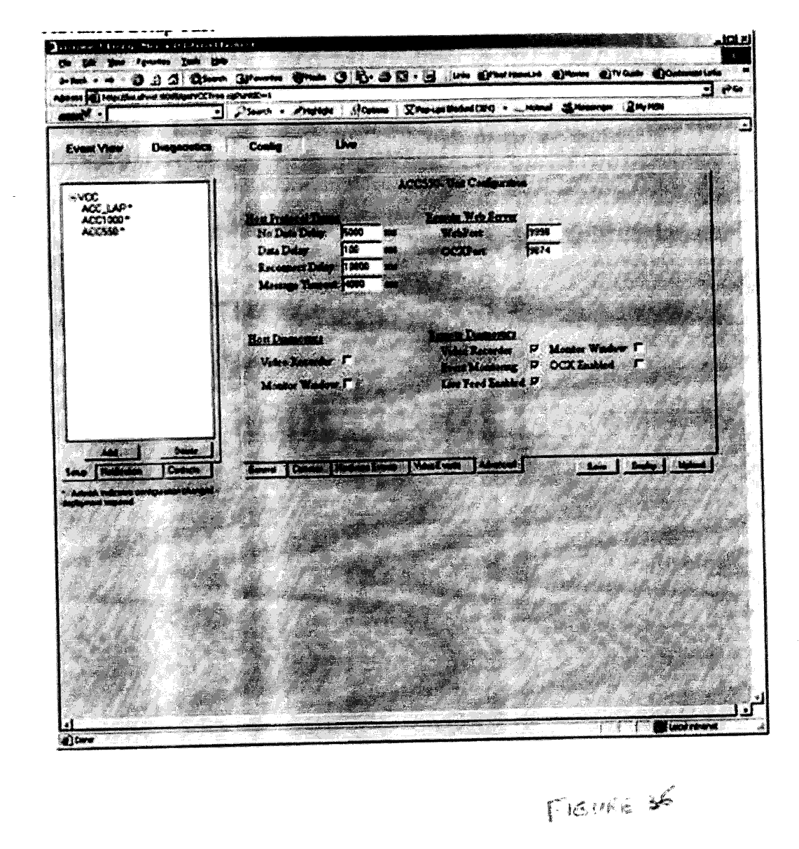

FIGS. 24 through 37 are screen shots.

As shown in FIG. 1, a system 10 provides video monitoring at a remote facility 12 of a remote location 14. The system is particularly useful in utility environments (such as municipal water sources) that have remote facilities 12 connected to a low-speed dedicated communication network 16 for purposes of control and monitoring of the remote facility and the remote location from a central location 18. The system 10 is highly scalable and can support a large number of remote locations served by very low bandwidth networks as well as locations served by high bandwidth networks. The system can also use existing communications infrastructure such as PLC (Programmable Logic Controller) networks. The use of highly adjustable video compression and alarming options and event based alarm video clips (which are tiny in terms of bandwidth required when compared to continuous live video) are also helpful in allowing reasonable functionality even when the bandwidth is low.

Remote Video Engines

One or more Remote Video Engines (RVEs) 20, 22 are connected to the existing low-speed (e.g., speeds of 9600 to 56K bits per second) plant local or wide area network 16 as are the existing programmable logic controllers (PLCs) 24, 26 (which may be used, for example, to control and monitor pumps or mixing equipment or a wide variety of other devices).

Each RVE gathers data from one or more cameras 28, 30 and alarm sensors (not shown). The gathered data includes, for example, one or more of the following: (a) high quality continuous Digital Video Recorder (DVR) files that are stored on a local disk storage device 21, 23 on the RVE; (b) medium quality video alarm clips that capture events just before, during, and after an alarm and are stored on the local disk; (c) low quality live streaming video that stream through the existing factory network 16; and (d) alarm status messages.

Each RVE includes a built-in communications server 25, 27 that provides access to its data and supports a variety of application protocols, including an appropriate protocol for use by a Video Control Center (VCC) 32 at the central location. The RVE can also support an existing PLC protocol for access to status information generated by or stored in the RVE (but not actual video). This allows existing factory applications such as Intellution's iFIX, Wonderware's InTouch or Rockwell's RSView (which typically already have the capability of using the PLC protocol) to access much of the data in the RVE.

The Video Control Center (VCC)

The VCC 32 is a software application that runs on a separate computer at the central location 18, is coupled to the local area network 16, and fetches data in the form of, for example, alarm messages, live streaming video, and alarm video clips from the RVEs over that network. All of the data is placed in a dedicated relational database 34 on disk files 36, where it can be accessed by a user interface (UI) Server 38. The VCC provides runtime status information to the UI server and also assists the UI server by providing a live video stream server.

The UI Server

The UI server serves web pages that provide a user interface for human end users 40. The web pages enable the user, among other things, to configure all aspects of the system, monitor system status and diagnostics, and view alarms, live video, and alarm video clips. The UI server may include in the web pages stored data from the relational database 34 and live data obtained from the VCC.

These web pages can be accessed via an Intranet or the Internet 42. The data in the pages can also be embedded in existing applications as HTTP/HTML content.

While text and status information is provided as pure HTML, the recorded or live video data is displayed in the web pages using a specially written video player object.

The Database

All of the system configuration parameters as well as all of the runtime alarms and events are stored in the relational database.

The configuration parameters include settings for the RVEs and VCC, and notification rules.

The runtime alarms and events include detected security events (for example, the detection of an intruder in a water pumping station) as well as any system events of interest such as a record of any system startup, shutdown, communication loss, or unexpected software errors.

This information is queried by the UI server to generate most of the Web pages displayed to the operator.

The Video Player

While text and status information can easily be displayed in a web page, the video information requires a special video player object 44. This object is somewhat similar in design to conventional media player objects such as Windows Media Player or Real One Player but is optimized for this application. It is designed to communicate with the streaming video server module 46 of the UI server. Like other media players, it is designed to be downloaded automatically and installed into the browser over the web the first time it is used.

The Notification Manager

A notification manager 50 monitors the relational database 34 for outstanding (unacknowledged) alarms. When an alarm is found, a user-defined set of rules is used to send emails and/or pager notifications to selected individuals. The user 40 may acknowledge the alarm by responding to the email. He will typically then use a web browser to access the UI server to obtain more detailed information about the situation.

Other Features

Other features are also described below including the following. The VCC and RVEs can share the existing network 16 with existing applications and PLCs 24, 26 which makes the system economical and easy to install and use. Complex, compressed video streams can be transported in multiple formats efficiently and reliably using existing, limited protocols (such as DF1) that were not designed for such data. Both hardware and software alarm triggers can be linked to multiple video streams as well as multiple hardware outputs, which makes the system more flexible and useful. Video can be captured before, during and after an alarm trigger, which provides the data the operator really needs to assess any situation. Video may be captured from multiple cameras based on a single trigger and the video from the multiple cameras can be played back on a single page, which improves the operator's ability to assess any situation. The parameters of the video settings (length, quality, frame rate) can be traded off against the responsiveness of the system and the network load, which increases the range of applications to which the system can be effectively applied. Video can be gathered simultaneously in multiple formats under user control (DVR hi-resolution and/or triggered alarm clip medium resolution and/or live feed low-resolution), which increases system flexibility. Live feed may be provided automatically only when needed, which greatly improves system performance in low bandwidth environments. Multiple remote units may be monitored simultaneously using different protocols, different data rates, and different video settings, which allows optimal use of diverse resources. The RVE responds to standard PLC-style requests for data from existing applications, which eases the integration of the system in the operational environment of existing installations. Key parts of the user interface (particularly alarm history and video functions) may be implemented in controls that can be embedded in existing applications as well as web pages, which provides flexible and effective access to the data by operators from different environments. Notifications can be performed using email or pagers based on a user defined set of rules, which improves operational flexibility when the central control room is not manned.

RVE Remote Video Engine

The RVE is a combination of hardware and software mounted at the remote site and is connected to up to four cameras and optional discrete inputs (not shown in FIG. 1) and to a communications link connected back to the control room that is typically shared with existing control equipment such as the PLCs.

RVE Hardware

The specific hardware for some example implementations is described below. However, the system is capable of running on a variety of other hardware platforms included but not limited to conventional personal computers (PCs) with inexpensive universal serial bus (USB) video cameras, dedicated embedded PC platforms, internal hard drive or removable flash drive, serial COM port(s), Ethernet port(s), USB port(s), built-in digital (discrete) inputs and outputs (16 each), built in video frame grabber, and external conventional video cameras with optional pan, tilt, and zoom capability.

To reduce cost, the implementations described here use a frame grabber in which a single video-processing chip is multiplexed between four input channels. A dedicated video chip per channel would potentially provide higher performance. The hardware selected for the industrial market that is the primary target of the product is ruggedized and its performance is well matched to the application. Such ruggedized hardware provides environmental tolerance, speed and reliable operation as required in field-based industrial monitoring. The system typically operates without a display or keyboard attached (much like a dedicated file or web server).

RVE System Software

The RVE runs Windows XP/Embedded. This provides a good balance of low cost, flexibility, robustness and a convenient development environment. Other systems such as Windows/CE or Linux could also be supported.

The application software uses the Microsoft DirectX/DirectShow video framework. Again this provides some basic video capability that saves time in the development effort but it is not a prerequisite to the implementation.

RVE Application Software

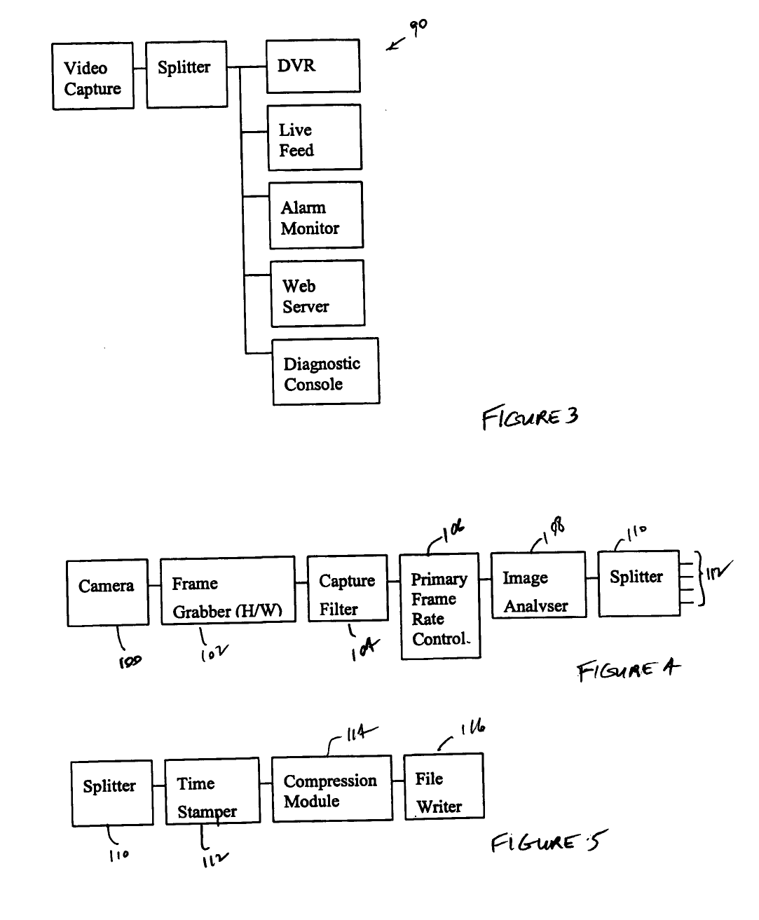

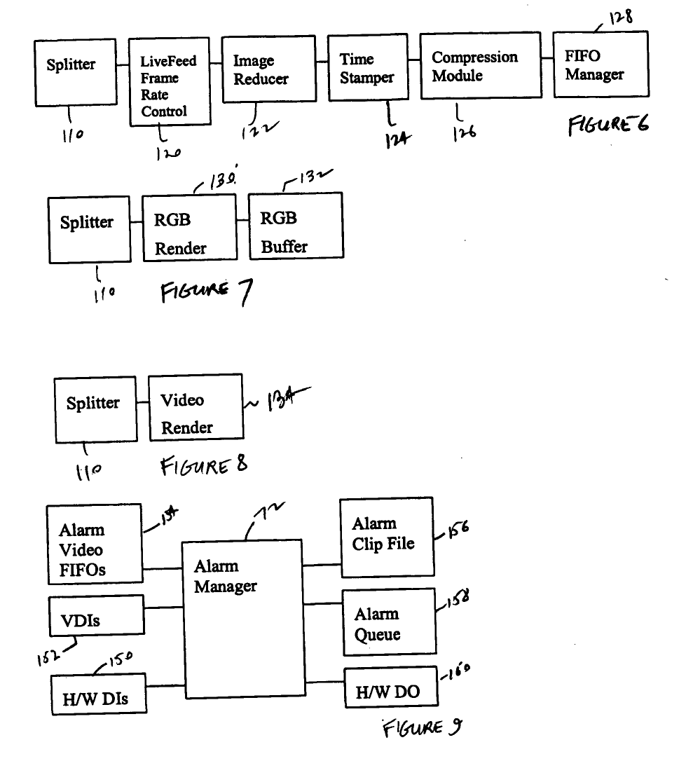

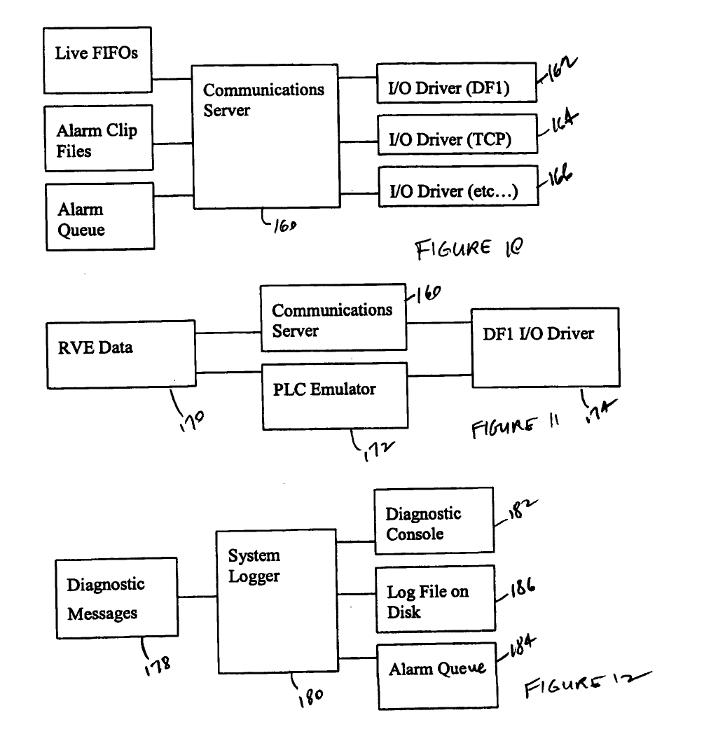

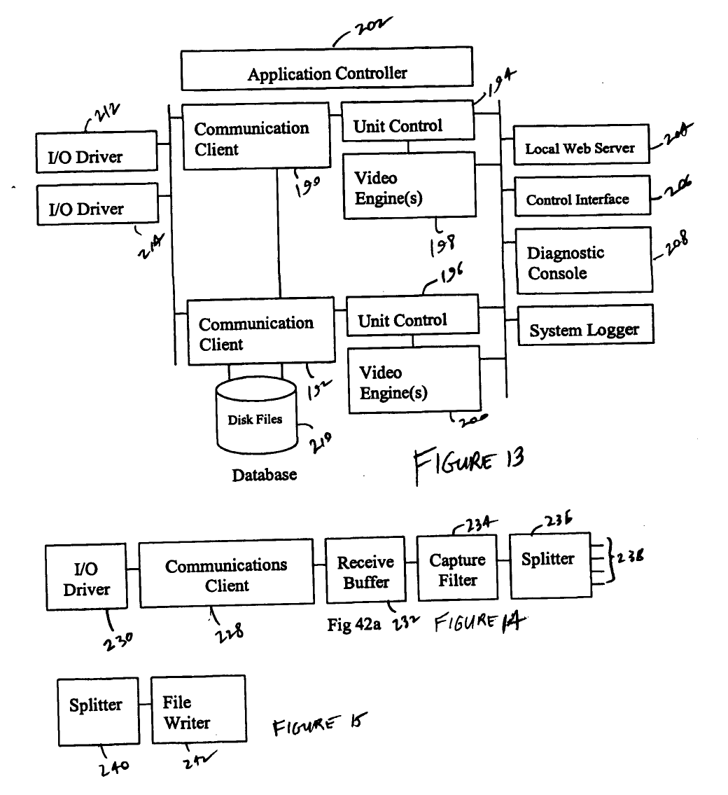

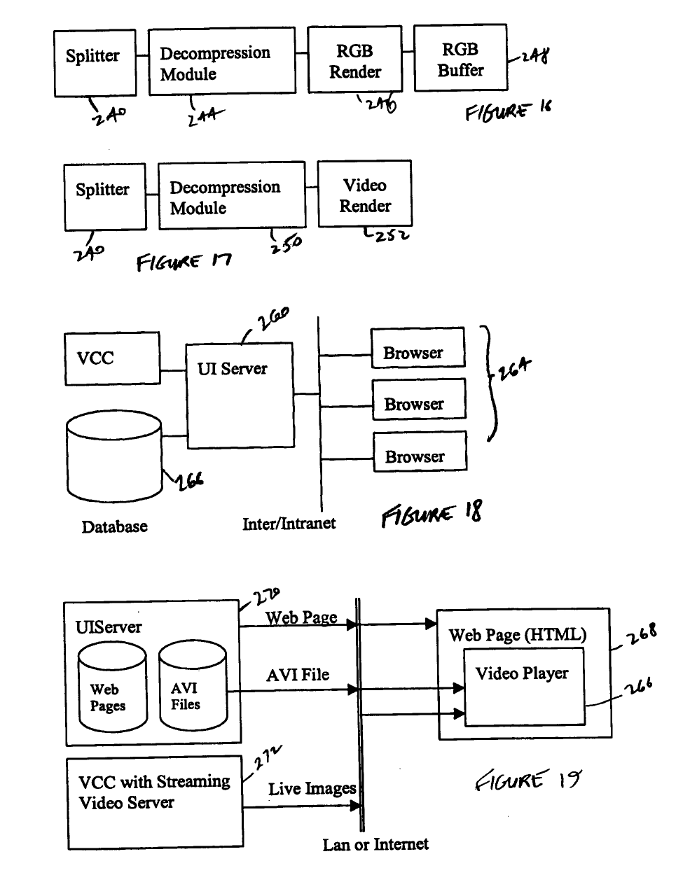

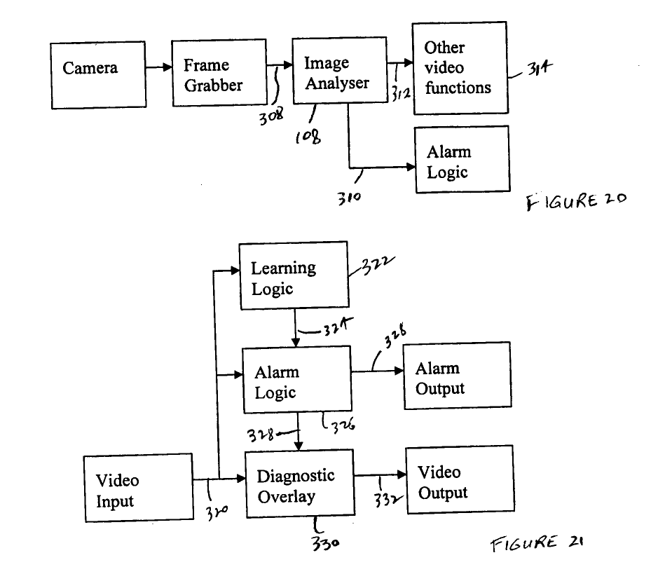

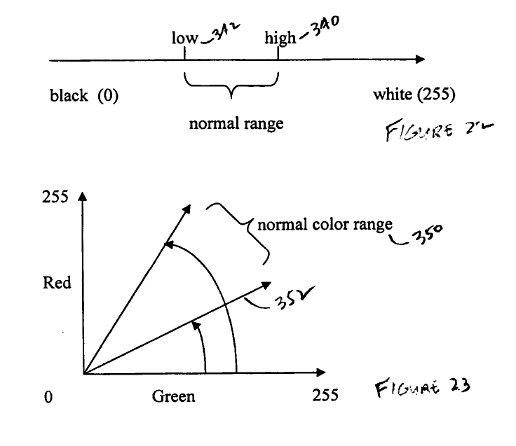

As shown in FIG. 2, the RVE application software 60 includes several major modules and sub-modules that are interconnected in various ways. These include an application controller 62, a video engine 64, a communications server 66, a communications I/O driver 68, a PLC emulator 70, an alarm manager 72, a local web server 74, a diagnostic console 76, and a system logger 78.

The application controller runs on startup and creates the web server, communications server, alarm manager, diagnostic console and video engine software components for each camera on that RVE. The communications server monitors the network for data requests and obtains data as needed from the other components.

The operation of each component is described in detail below.

The user can set a variety of parameters that control the overall operation of the system. The parameters are listed here although it will be useful to understand the system components (discussed later) in order to understand them.

CameraCount—the video hardware supports multiple cameras. The user might not be using all of the possible inputs.

WebPort—this is the TCP port to be used by the HTTP portion of the local web server (discussed below).

OCXPort—this is the TCP port to be used by the streaming video portion of the local web server (discussed below).

Driver Setup—this specifies what driver to use (e.g. DF1, TCP, SIO, etc) and what parameters to use in the setup of that driver (port number, baud rate, etc).

AutoDelete—this indicates how many days old files should be kept. These include DVR files, alarm files and log files.

FileHours—indicates how long each DVR (digital video recorder) file should be.

DVR Enable—enables/disables the high resolution DVR function.

Monitor Enable—enables/disables the diagnostic video monitor function.

AlarmClip Enable—enables/disables the medium resolution video alarm clip function.

LiveFeed Enable—enables/disables the low resolution live video feed function. Additional parameters that are specific to the video processing can also be set and are discussed below.

Additional parameters that are specific to the alarm handling can also be set and are discussed below.

Application Controller

The application control module handles the main startup and shutdown of the RVE application. It coordinates the connection and operation of the other components. This includes initial loading of the application configuration parameters, configuration and starting the other components according to those parameters and monitoring for user requested configuration changes.

In particular it creates a video engine module for each camera to be monitored.

Video Engine Module

As shown in FIG. 3, the video engine is a software system based on the Microsoft DirectShow framework. It acquires and processes the video data and routes it to the various other sub-components as shown above. The operation of this component and its internal sub-components is described below by following the video data thru the processing logic. The specific connections between sub-components described below represent a good balance between flexibility and performance. Other permutations of the sub-components are also possible.

There is a separate video engine running in the RVE for each camera. Each engine enables the user to select a variety of options and tuning parameters to optimize performance for his application. The options for each engine/camera can be set independently. The system is designed to allow easy addition of tuning parameters as needed. The options may include:

DVR video quality—this balances picture size versus quality for the high resolution DVR files

DVR frame rate—controls the frames per second in the DVR files

DVR timestamp—controls the size, color and position of the timestamp

AlarmClip Video Quality

AlarmClip Video Before/After/Framerate—controls the start, end, duration and frames per second for Alarm Video Clips

AlarmnClip timestamp—controls the size, color and position of the timestamp

Live Feed Video Quality

Live Feed Video Framerate—controls the frames per second for the low-res live feed.

Live Feed timestamp—controls the size, color and position of the timestamp.

Common Video Capture

As shown in FIG. 4, the video from the camera 100 is captured a frame at a time by the frame grabber hardware 102. The frame grabber contains an uncompressed bitmap of the image. The size of the initial acquired image (called the ‘native’ size) can be user-selectable. The default size is 320×240. Each new copy of the image (bitmap) overlays the old copy. The image delivery timing is a function of the hardware. As each image arrives a message is sent to the video engine software. A software component called the capture filter 104 makes a copy of the bitmap.

There is no requirement that the software process every frame. The software always processes the latest available frame. If some frames that have been delivered by the hardware are missed, this does not cause a problem. This allows graceful degradation of performance if the system should become overloaded. The bitmap stream is delivered from the capture filter output to the primary frame rate controller 106. This is a software component that provides video frames to the rest of the engine at a rate selected by the user: 30/sec, 10/sec 1/sec 1/sec, etc. It does this by skipping some of the frames provided by the hardware. This is needed because the range of frame rates provided by the hardware (if any) is generally not flexible enough. This allows the performance of the system to be optimized for a particular installation. The frame rate (and resolution) determine how much space is required for disk files, how much communications bandwidth is required for live or alarm video and how much CPU power is required to process the video. For example, a system with one camera can provide better image quality (higher resolution and frame rates) than a system with four cameras.

The bitmap stream is delivered from the primary frame rate controller output to the image analyzer 108. The image analyzer ‘learns’ the normal behavior of the scene. Specifically it divides the scene into cells (typically 10×10 pixels) in order to reduce processing load and records the normal variation in both the direction (hue) and length (intensity) of the color vector for each cell. This allows the system to work well in both a multispectral environment (color) and single spectrum environment (black and white or infrared). Any significant variation from the normal range triggers a ‘cell’ level alarm. The sensitivity of this test is adjustable by the user. Adjacent cell level alarms are joined to create a region of interest (ROI) that represents a potential intruder or other disturbance.

The largest ROI in the image is identified and if it exceeds a user settable size and duration threshold then a virtual digital input bit corresponding to this stream is set and an alarm is generated. (See the alarm manager discussion). An additional filter can be applied to the aspect ratio of the ROI to determine if it is likely to be a human or not. The system continues to learn the scene behavior and refreshes its settings periodically. An algorithm allows learning to be suppressed while an alarm is active as well as suppressing spurious alarms due to either abrupt or gradual changes in illumination.

A variety of graphic options are provided to overlay information onto the image. The most common option is to outline any alarmed ROI in a red rectangle. Although placing the image analyzer before the frame rate controller would allow access to more data and potentially somewhat more robust alarming, placing it after the frame rate control allows a more reasonable use of CPU resources.

The bitmap stream is delivered from the image analyzer output to a splitter 110. This software module delivers the same bitmap image to multiple internal processing streams. These include the DVR stream, the live feed stream, the alarm clip stream, the local web stream and (optionally) a simple on-screen monitor window which is part of the diagnostics console used for testing. These streams can each be enabled or disabled under software control as needed for a particular installation. Each of these continuing streams is described below.

DVR Stream

As shown in FIG. 5, the bitmap stream is delivered from the splitter output to the time stamper 112. This software overlays the current date and/or time on the image. The position, font, and size of the text are user selectable. Although not implemented in the product, an alternate approach is to attach the date and time information to the image as metadata. The bitmap stream is delivered from the time stamper output to the compression module 114. A variety of compression algorithms could be used. Some implementations use the Microsoft Windows Media 9 compression algorithm that is similar to MPEG4.

The output of this module is a series of ‘K’ and ‘I’ frames (also known as ‘key’ and ‘delta’ frames). The ‘K’ frame contains the entire image in a highly compressed format. The ‘I’ frames contain incremental changes to the image that are also highly compressed. Because only the changes to the image are included in the I frames and because in general most of the image will be quite stable, the reduction in space required to store the stream of images is extremely high (on the order of 97+percent). The compression settings are user settable. One important setting is the ‘bit rate’. This setting instructs the compression algorithm to deliver the best image possible while not exceeding the specified bit rate. This can be set quite high for images stored to a local disk or can be set quite low for images to be delivered over the low bandwidth communications network. In the case of the DVR stream, this value is typically set high. When this type of compression is used, it is critical that no frames are missed. This is because each ‘I’ frame builds upon the summed total result of all previous I frames back to the last K frame. For example one could deliver large numbers by sending the initial value 12345678 followed by shorter incremental (I) values; +101, −42, +316, −29 etc. It can be seen that if any of the values is missed then all subsequent values will be wrong. It is vital that the system detect and correct for any lost I frames. This concept will be important in later discussions.

The stream of compressed frames is delivered from the compression module output to a file writer module 116 that stores them in a conventional AVI format in a disk file. Because of their format, AVI files are not useful (i.e., viewable) until they are complete and closed. The user can select how often the files should be closed (e.g. once per hour). A new file is opened (started) each time the previous file is closed. If necessary, the user can force the current files to be closed immediately (for example, if a file which is not scheduled to be closed for some period of time needs to be reviewed immediately in an emergency.) A new file will immediately be started.

Live Feed Stream

As shown in FIG. 6, the live feed stream is designed to provide live video back to a central viewing station (typically located in a control room or monitoring station.). The bitmap stream is delivered from the splitter output to the live feed frame rate control 120. This allows a further reduction in frame rate to accommodate the available communications bandwidth. Frame rates of I frame per second to 1 frame per 30 seconds are typical. This setting is user adjustable. The bitmap stream is delivered from the live feed framerate output to the image reducer 122. This reduces the size of the image (e.g. from 320×240 to 160×120) in order to further reduce the bandwidth requirements. Reducing the dimensions by a factor of 2 (as in this example) reduces the bandwidth needs by a factor of 4. The reduction factor is fixed at 2 in this example, but can easily be made adjustable. The bitmap stream is delivered from the image reducer output to the time stamper 124. This software overlays the current date and/or time on the image. The position, font and size of the text are user selectable. The reader will note that there is more than one time stamper module. This is because the image may be reduced in size for some streams. In order to be readable the time stamp must be added to the image after the final image dimensions have been set. The bitmap stream is delivered from the time stamper output to the compression module 126 that operates as described above. Note that in this case (the live feed stream) the ‘bitrate’ setting is typically set quite low.

The resulting compressed frame stream is delivered from the compression module output to the FIFO manager 128. The stream of compressed frames is delivered at a fairly constant rate as determined by the frame rate control. However the frames are highly variable in size and the communications server (described later, which delivers the frames to the video control center (also described later)) is subject to highly variable network traffic conditions. For this reason, a first-in-first-out queue (FIFO) is maintained in which frames can be buffered until they are sent.

The FIFO has multiple modes of operation. In this example, it is set for ‘Live Feed’ operation. This enables an optimization where whenever a ‘K’ frame (containing the complete compressed image) arrives in the FIFO, any old data is deleted from the FIFO. Since the purpose of this stream is to show data that is as close as possible to ‘live’ there is no point in delivering the ‘stale’ data in the FIFO when a new ‘K’ frame arrives. This feature allows the live feed system to more easily ‘catch up’ when the communications network is unable to maintain the data flow at full speed and is important to the success of the system in low bandwidth applications. Another feature of the Live Feed’ mode of operation is that it allows users of the video stream (in this case the VCC) to operate in an ‘on demand’ mode. The data can be fetched only when needed; for example when the operator requests a live view. This saves bandwidth which is the main limiting factor in most installations of the system. The compressed frames are fetched from the FIFO by the communications server based on requests from the VCC (as described later).

Alarm Monitor Stream

The alarm monitor stream is designed to work with the alarm manager in order to capture a video clip starting several seconds before an alarm is tripped and ending several seconds after an alarm is tripped. (The logic of the alarm detection is described later). It is similar in structure to the live feed stream. That is, the video is delivered from the splitter to a frame rate controller, an image reducer, a time stamper, a compression module and a FIFO manager. The operation of this stream differs slightly from the live feed stream as follows:

The settings provided by the user may be different. In particular, the alarm monitor stream will typically provide higher quality video than the live stream.

The FIFO manager operates in recorder mode. In this mode it operates as a normal FIFO in which frames are delivered to the input end and stored in a list. If the list becomes full, old frames are dropped from the output end.

The alarm manager fetches the compressed frames from the FIFO in order to create the before/after video clip. This is described later. The size of the FIFO is automatically set to insure that at least ‘before+after’ seconds of video will be available in the FIFO.

Local Web Stream

As shown in FIG. 7, the local web stream is designed to provide live video into a web page. It works with the local web server that is described later. This is typically used by the end user while setting up the cameras at the remote site. For example, the user might use a small handheld PC connected to a wireless Ethernet adaptor. The user carries this portable PC to the camera location, make adjustments to the camera, and sees the results on this portable PC.

The bitmap stream is delivered from the splitter output to the RGB render module 130. The RGB render module stores the bitmap in a shared memory area called the RGB buffer 132 from which it can be fetched by the streaming video server. A key feature of the RGB buffer is that it includes information about the size, requested frame rate and timestamp for the image. The timestamp allows software that requests the image (such as the video player) to determine the age of the image and notify the operator if the image is ‘stale’—i.e., is older than a predefined limit.

Diagnostic Console Stream

As shown in FIG. 8, the diagnostic console stream is designed to provide live video on a monitor attached to the embedded PC on which the RVE software is running. This is used primarily for testing since in general the system will run at a remote location with no monitor attached.

The bitmap stream is delivered from the splitter output to a video render module 134. The video render module (which is a part of the Microsoft DirectShow Framework) writes the bitmap directly into a window on the video screen of the monitor.

Diagnostic Console

The RVE diagnostic console is intended primarily for use in testing the software. It is generally not used by the end user. It runs as a text window on the optional video monitor attached to the embedded PC and monitors input from an optional PC keyboard attached to the embedded PC. It shows a diagnostic trace of the operation of the system (see also system logger). Different levels of trace can be enabled using different key combinations. Also various system operations such as restart as well as alarm triggers and even system errors such as communications errors can be simulated from the keyboard. This allows the system designers to more easily and completely test the system operation.

Local Web Server

The local web server can be used by the end user during system setup. It allows the user to set the initial configuration parameters to enable communications, do file management, and monitor live video from the cameras in a web browser.

The web server includes two main components:

One is a conventional HTTP server. It serves pages that are created using conventional HTML. These pages can be static or can be dynamically generated using a function similar to conventional CGI scripts or ISAPI add-ins and can also include dynamic server-side substitution of values within the HTML. Such techniques are in common use.

The second component is a streaming video server. This is designed for use with a specially written video player control that runs as an object in the web page. A single TCP socket is used to connect the streaming server to the video player object. The socket can be used in two modes: command mode or streaming video mode. In command mode the client can send commands or requests to the server using an extensible protocol and get replies. If the client requests the socket be put in streaming video mode then the outbound side of the socket includes a series of video frames which are obtained from the RGB buffer module described above. In that case, the only command the client can send is to stop the stream and place the socket back in command mode.

Alarm Manager

As shown in FIG. 9, the alarm manager 72 monitors hardware digital inputs (DIs) 150 and also virtual digital inputs (VDIs) 152. When an alarm condition is detected, a video clip containing images from before, during, and after the event is generated from data in the alarm video FIFOs 154 and is saved as a disk file. An alarm message is queued 158 for the VCC indicating that this file should be uploaded.

The user can set a variety of parameters that control the overall operation of the alarm manager. The system is designed to allow easy addition of other parameters. The parameters include:

DI Normal/Delay—sets the normal state (open, close) and debounce time for each hardware DI. A hardware digital input enables the RVE to be interfaced with existing intrusion detection equipment (e.g., motion sensors, door switches, etc.)

DI Trigger Mask—for each DI, this indicates which video alarm clips 158 and which hardware outputs 160 should be triggered when an alarm is detected.

VDI Tuning—sets the parameters that govern the sensitivity of the video image analyzer logic. These include sensitivity, object size, and object aspect ratio settings.

VDI trigger mask—for each VDI, this indicates which video alarm clips and which hardware outputs should be triggered when an alarm is detected.

The functions performed are discussed in more detail below.

Currently up to four hardware DIs are monitored (up to 16 or more could easily be supported) and up to four VDIs (one per camera) are monitored. As mentioned earlier, the VDIs are set by the image analyzer based on suspicious activity detected in the images.

The user can override each DI and VDI and force it to SET or CLEAR. There are two ways to do this: One is via commands in the video system application communications protocol (which can originate in the video control center computer or in system-provided web pages from a computer located on the local area network.) The other way to override a DI or VDI is by using the PLC emulator interface provided with some of the I/O Drivers. (Some implementations can support this in a Allen-Bradley DF1 I/O driver.) See the PLC emulator discussion later.

The user can set a deadband time for each DI/VDI such that any value that is SET for less than that time is ignored. Inputs that are set for more than this time are considered real alarms. This logic helps reduce spurious alarms.

The DI/VDI alarms can trigger one or more hardware digital outputs (DOs) and one or more alarm clips. The digital outputs are useful for interfacing the RVE to other external subsystems (such as sirens or lights). For example DI-2 can trigger hardware outputs 3 and 4 and also alarm clips on streams 1 and 2. In addition, an ‘alarm event’ message is queued for transmission to the VCC. Each alarm event is assigned a unique identification tag. This is so that alarm event messages can be handled more easily in the relational database. In particular it allows other information related to this alarm (such as the alarm video clips) to be easily associated with the initial alarm event.

The alarm clip logic operates as follows: Recall that the user can set ‘before’ and ‘after’ times for the alarm clips. When the trigger event (DI or VDI) is detected, a timer is started and set to ‘after’. When this timer expires the alarm monitor FIFO (discussed earlier) is examined. Recall that the FIFO will contain at least ‘before+after’ seconds of video in the form of compressed frames. These frames are extracted from the FIFO and stored in a local file. An ‘alarm clip ready’ message is queued for transmission to the VCC. This includes the ID of the original event and the name of the file containing the clip.

An algorithm insures that the FIFO size is sufficient to contain all of the before and after video data. In addition, because the data is in the form of compressed frames and because the first frame of the clip must be a ‘K’ frame, the FIFO must be large enough to insure that there is a ‘K’ frame available at or before the start time of the alarm clip. The basic formula for the FIFO size is:
(Before+After+KeyFramelnterval)FramesPerSecond.

A feature of the system is that the alarm clip file is stored as a binary image of the actual compression filter output. This is approximately half the size of an actual AVI file and thus greatly reduces the time needed to send the alarm clip over a low speed network.

After receiving the ‘alarm clip ready’ message, the VCC will use the communications server to read the file as described later. It will then convert the file into a larger but more conventional AVI file.

Communications Server

As shown in FIG. 10, the communications logic of the RVE is in two layers. Most of the logic is independent of the actual transport (TCP, DF1, MODBUS, etc) and is contained in the communications server 160 (described here). Some of the logic (including the PLC emulator) is specific to the network and protocol in use and is described in the next section.

The communications server handles video system application layer messages that relate specifically to communications between the VCC and RVE. The system is designed for a ‘polling’ environment in which the VCC is the master (client) and the RVE is the slave (server).

Each message transaction includes a request sent by the VCC and a reply sent by the RVE. This communications layer is extensible and currently contains the following messages:

Status Request—used to determine if the RVE is online.

Control Command—used to send an extensible set of runtime control requests to the RVE. These include Unit Restart, Shutdown, Pan/Tilt/Zoom requests among others.

Query compression settings—used to query the video compression parameters. The decompression algorithm in the VCC needs to know the parameters used by the compression algorithm in the RVE.

Query available data—used to determine if the RVE has events, alarm clips or live video data available.

Read live video frame—used to read the live video data if available.

Read event message—used to read an event message if available.

Read alarm clip message—used to read an alarm clip notification message if available,

File read begin—used to begin the upload of files including configuration data or alarm video clips.

File read—used to continue and complete the upload of files.

File write—used to begin the download of files including configuration information.

File write complete—used to complete the download of a file.

Network 1/O driver (TCP, DF1, SIO)

As shown in FIG. 10, the I/O driver layer includes a module 162, 164, 166 for each supported protocol. In various implementations, these could include:

TCP—the commonly used LAN/Internet Protocol.

DF1—a commonly used industrial protocol developed by Allen Bradley (See Allen Bradley DF1 I Protocol and Command set Reference Manual). This is typically used over low speed RS485 serial communications networks.

SIO—a protocol developed specifically as an alternative to DF1. This can be used with exactly the same communications hardware setup applications where DF1 is not in use (e.g., low bandwidth multi-drop serial communications networks).

Each I/O Driver module performs operations on behalf of the Communications Server described above. It is responsible for opening and closing a connection to the network and sending and reading data packets for the network.

It is common for network level drivers to support more than one application level message protocol. When this is the case, messages received from the network are examined and routed to the module equipped to handle them.

In the example implementations discussed here, as shown in FIG. 11, all drivers support the video system application protocol messages as used by the RVE 170 communications manager to communicate with the VCC. Messages found to have this format are routed to the communications server.

Some of the drivers (such as the DF1) also include support for standard PLC application protocol messages. Messages found to have this format are routed to a PLC emulator 172. In this case the DF1 driver 174 supports the standard Allen Bradley DF1 messages as mentioned earlier.

Supporting this additional standard Allen Bradley protocol in parallel with the video message protocol on the existing network allows existing third-party applications that already understand the Allen Bradley protocol to get access to much of the data contained in the RVE. This includes the DI, VDI and DO values as well as alarm and status information which can be made to appear as standard PLC data.

PLC Emulator (DF1)

As mentioned above a PLC emulator is implemented for protocols such as DF1 that are commonly used to talk to conventional PLCs. This allows existing applications that are already equipped to talk to PLCs (such as industrial human machine interface (HMI) software, data loggers, etc.) to access the DI, VDI and DO values as well as alarm and status information which is made to appear as standard PLC data.

System Logger

As shown in FIG. 12, the system logger 180 is used primarily for diagnostics. Various parts of the system send messages 178 to the logger about operations being performed. Each message is flagged as ERROR, INFORMATIONAL or DEBUG. There are system settings that determine which messages are included in the output and which are ignored. For example when the system is operating normally only ERROR messages would be reported so as to save time as space. However while trying to locate a problem additional messages (INFORMATIONAL and/or DEBUG) would also be reported. The logger routes the messages to: (a) the diagnostics console 182 where they are displayed in a window (and can be filtered according to importance), (b) the event message queue (only in the case of ERROR messages) 184 and optionally (c) a log file (text) on disk 186. This disk file is closed every hour and deleted after 30 days so as to limit the space consumed. The files can be manually copied to a separate PC or uploaded over the network to help diagnose system problems.

Video Analyzer Details

The analyzer (also called the “video cortex”) is a software module that is used as a component in a larger video surveillance system, for example, as the analyzer 108.

As shown in FIG. 20, the analyzer accepts a video stream 308 as input, learns normal characteristics of the images captured and then monitors the video stream for suspicious activity. A master alarm output 310 is set if such activity is detected. The video stream 312 can be passed on 314 as-is for additional processing or various alarm and diagnostic information can be overlaid on the image. The processing is both robust and efficient making the system suitable for use in relatively low cost products with limited computing power.

Typically the system incorporating the analyzer will include other components constructed within a video processing framework such as Microsoft DirectShow.

The analyzer attempts to emulate in software much of the low level processing of the human eye and visual cortex in terms of object detection and prioritization. That is, at the eye level it quickly learns what sort of color and intensity variation is normal for each area of the image and then watches to detect anything that does not fit that normal behavior. Whenever these low level anomalies are detected, information about them is passed on to higher level brain functions for analysis and decision making.

The analyzer includes a gated learning algorithm which allows it to adapt to changing conditions while not inadvertently learning bad behavior as normal.

A variety of easy to use and intuitive tuning parameters are available to maximize sensitivity and minimize false alarms while keeping the system easy to manage and set up. A comprehensive and flexible set of diagnostics allow testing and tuning.

The analyzer can be used with any video stream that provides RGB24 format images, a standard video format, and could easily be adapted to other formats if needed. The analyzer can operate on either color or black and white images and is independent of the frame rate and resolution.

The analyzer is implemented in the Microsoft DirectX/DirectShow video framework and could easily be adapted to other software environments.

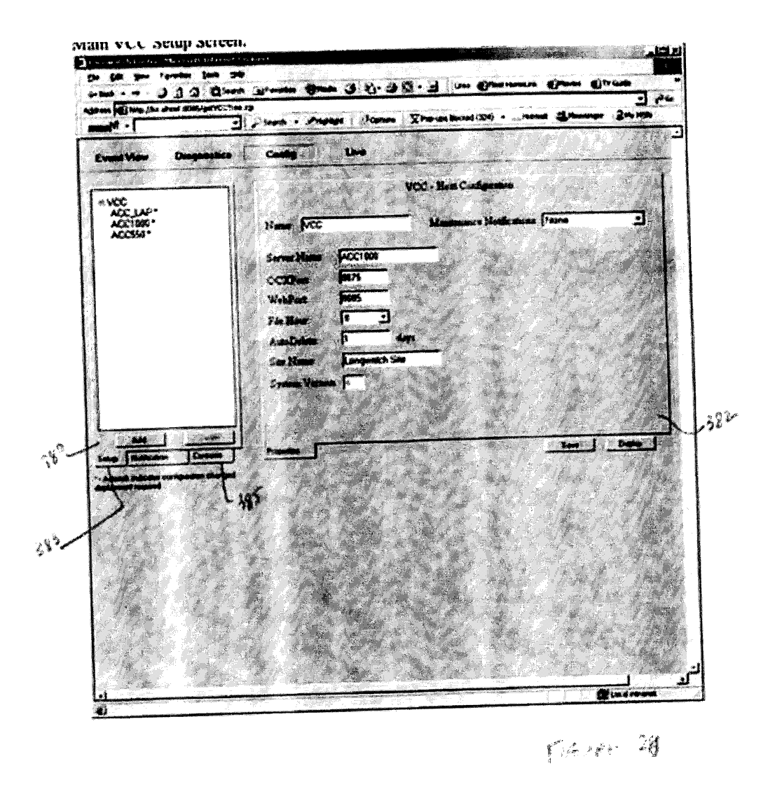

The basic architecture of an implementation of the analyzer is shown in FIG. 21. The video input 320 stream is passed to the learning logic 322 that learns the normal behavior of the scene as a set of limits and vectors 324 (the ‘vectors’).

The video input stream and the vectors are passed to the alarm logic 326 which examines the current input stream for suspicious activity such as intruders. If such activity is detected then an alarm output 328 is set. The output is a software output that can be monitored by any other component of the overall surveillance system.

The video input stream and the alarm output are also passed to a diagnostic overlay module 330. This module can overlay a variety of information onto the image to assist the user in analyzing the nature of the alarm.

The output 332 of the overlay module is the same as the input video stream with optional diagnostic and alarm information overlaid on it much like a VCR or cable box overlays information on a TV picture. This is passed back to the higher level application for use as needed.

When the analyzer is first activated its internal logic remains idle for some period of time (the warmup period). This is because many cameras and frame grabber hardware require several seconds during which to adjust to the overall lighting of the scene.

After the warmup period the analyzer enters a learning mode. During this time no alarm checking is done because the system needs to learn the normal behavior of the scene.

After the initial learning period is complete the system enters checking mode. In this mode the image is checked against the learned normal behavior pattern. Also in this mode the system continues to relearn the normal behavior of the scene over time so that it can adapt to changing conditions.

The methods by which the scene behavior is learned and the format in which the result of that process is stored make the analyzer efficient and robust.

Some important design issues to be addressed in implementing the analyzer include the following.

The analyzer must not learn the behavior it is supposed to be alarming. However at times there may be a permanent change in the scene; for example a parked car or a light being turned on or off. The system must not continue to alarm indefinitely on such a change. This and the previous requirement together present a challenge.

Video streams contain a lot of data, are time consuming to process, and (especially as outdoor scenes) contain a lot of low level noise which must not generate alarms. Video streams change over time; for example between day and night. So continuous learning in some form is required. In particular new behavior must be learned over time and old behavior must be unlearned over time.

The learning logic addresses these issues using a variety of techniques: gated learning, cell based analysis, color limit vectors, intensity limit vectors, vector hysteresis, and global scene vectors.

The basic learning algorithm finds the normal range of colors and intensity (the ‘limit vectors’) for each part of the image. This learning algorithm is normally disabled while the analyzer is in alarm to prevent learning the wrong behavior.

Periodically the newly learned vectors replace the old vectors. To allow for such issues as variable wind and other background factors, wider ranges in vector behavior are applied immediately while smaller ranges are applied with a lag.

For learning and analysis, adjacent pixels are combined into cells (in effect, just bigger pixels) to reduce the resolution of the scene and thus speed up processing. For each cell, the analyzer scans both the color range and the intensity for high and low limits. The analyzer can alarm on one or the other or both.

If the overall brightness or color of the scene changes, these global changes are applied immediately to the alarm logic in order to further improve sensitivity and reduce false alarms.

In order to prevent learning wrong behavior, the learning logic uses gated learning, operating over selectable discrete time periods, typically 1 to 5 minutes (timer1). The learning logic is active only while the scene is not in alarm (see exception below). This prevents erroneously learning unwanted behavior as normal. At the end of each learning cycle the vectors are marked as provisional and a delay timer (timer2) is started (typically 5 to 10 seconds). The scene (still being checked against the previous vectors) must remain unalarmed during this time. If an alarm is detected during this time it is assumed that the new learned vectors are compromised. They are discarded and a new learning cycle is started as soon as the alarm is cleared. In this case an override timer (timer3) is started (typically 5 to 10 minutes). If this timer expires and the alarm is still active then it is assumed that something permanent has changed in the scene (which the system operator will have been notified about) and so a new learning cycle is started regardless of the alarm state. If the provisional timer (timer 2) expires and there is still no alarm active then the provisional learned vectors are activated (see next section).

For purposes of intruder detection, analyzing the scene at the pixel level would be expensive (in both CPU and memory use) and unnecessary. Instead, groups of pixels are combined into cells (in effect, just larger pixels). Typically a cell will be 10×10 pixels but could be adjusted to trade off resolution against performance. In an image of 320×240 pixels (typical medium resolution) this results in 32×24 cells which is sufficient to detect intruders. Note that a cell size of 10×10 reduces the number of learning and analysis steps by a factor of 100.

As shown in FIG. 22, the intensity of each cell can be monitored during the learning phase and checked during the alarm phase. The intensity range is simply a low value 342 and a high value 340 along a continuum from black to white, a pair of vectors in a one-dimensional space. The analyzer learns the normal high and low range of intensity for each cell.

As shown in FIG. 23, the color of each cell can be monitored during the learning phase and checked during the alarm phase. Ideally, the color range 350 is a vector 352 tracing out an irregular cone in a three dimensional space with axes r, g, b (Red, Green, Blue). In practice, treating the color as a pair of 2D vectors (Red/Green and Green/Blue) is easier to implement. The analyzer learns the behavior of the angle (direction) of each vector rather than its length. When alarming on color we ignore the length of the color vector and look only at its angle. Treating the color as the angle of a vector rather than as the intensity of 3 discrete (Red, Green Blue) values makes the color alarming much less sensitive to changes in lighting. This is because the angle of the color vector for each cell indicates the color of the object which is relatively insensitive to the lighting intensity.

The analyzer needs to learn new behavior quickly but unlearn old behavior slowly. This is particularly important for example in outdoor scenes where the wind is gusty. So when the newly learned vectors (limits) are larger than the old vectors they are applied immediately; however, when the new vectors are smaller than the old vectors a first order lag algorithm is used.

The overall average intensity and color of the entire scene are monitored. Frame to frame changes in this overall average value are used to adjust the alarm limits. Thus if the overall image becomes brighter than it was during the learning phase (e.g., the sun appears from behind a cloud), then the intensity vectors are adjusted upwards. This also applies to the color vectors. This behavior helps reduce false alarms.

The alarm logic monitors the video stream and compares each frame to the learned intensity and color vectors. The methods it uses to do this enable it to reduce false alarms and the chance of missing significant events.

Each cell in the image is checked for alarm (a cell alarm); however, the system operator is not informed of these cell level alarms. Adjacent alarmed cells are then aggregated into alarmed objects. The characteristics of the alarmed objects are then checked against user provided limits. If these limits are exceeded then a master alarm is generated and the alarm output of the analyzer is set. Typically this will result on the system operator being notified.

A variety of parameters can be adjusted by the user to optimize the system for different environments and applications. These include:

Color enable—should color vector changes be alarmed? This is typically used for color video and is not used for black and white (or infrared) video.

Intensity enable—should intensity (brightness) vector changes be alarmed? This is typically used for black and white (or infrared) video but not for color video.

Color deadband—how far is the color allowed to vary outside the limit vectors before an alarm is activated for the cell?

Intensity deadband—how far is the intensity allowed to vary outside the limit vectors before an alarm is activated for the cell?

Deadband hi range boost—very bright cells are prone to false alarms. The intensity and color deadbands can be boosted for cells whose brightness exceeds this limit.

Deadband lo range boost—very dark cells are prone to false alarms. The intensity and color deadbands can be boosted for cells whose brightness is below this limit.

Color alarm cutoff—below a certain brightness the color vector becomes unreliable. This limit allows alarms on dark cells to be ignored completely thus reducing spurious color alarms in dark areas of the image.

Object size threshold—adjacent alarm cells are aggregated into objects (as described below). Objects whose size exceeds this limit will generate a master alarm that will generally cause the system operator to be notified.

Object aspect ratio filter—it is possible to examine the aspect ratio of an object (height vs. width) to make an approximate guess if the object is human or not. This might allow the system to distinguish a human from an animal for example before setting the master alarm. The user can optionally enable this capability.

The method for determining if a master alarm should be generated is as follows.

For each cell in the scene, compare the current intensity and/or color of the cell to the limit vectors. Take the tuning parameters above into account during this compare.

Aggregate adjacent alarm cells into objects. There may be multiple separate objects in the image. The algorithm for this is somewhat complex but essentially consists of finding the next alarm cell that is not already part of an object and then recursively looking at each of the eight adjacent cells. Any that are in alarm are added to this object.

Examine the list of objects and locate the largest object. There are several possible methods of determining the size (or ‘weight’) of an object. One method is to count the number of alarm cells in the object. Other possible methods might be to measure the maximum width and height of the object or to total up the amount by which each cell in the object exceeds the alarm limits.

If the size of the largest object exceeds the user defined limit and satisfies the optional aspect ratio filter then the master alarm is set.

Additional possible extensions to this logic could provide additional capability to the system.

For example, simple trigonometric calculations could be added to determine the location and distance of the object relative to the camera and potentially relative to other known objects within the scene such as doors, windows, or control panels.

The logic could remember objects from frame to frame enabling the analyzer to characterize and predict the movement of the object, to filter alarm notifications based on this behavior, and to potentially adjust (e.g., narrow) the alarm limits along the predicted track of the object.

The overlay logic draws text and graphics on the image to provide diagnostics to developers for testing as well as more meaningful alarm data to the operator.

The diagnostic and alarm text options include:

Current mode of operation: Warmup, Learning, Checking.

Current timer values (timer1, timer2, timer3)

Current number of cells in brightness alarm

Current number of cells in color alarm

Current image alarm state (the final virtual digital output value)

The diagnostic and alarm graphic options include:

Show a bounding rectangle (red) for the largest alarm object detected

Show a bounding rectangle (yellow) for all objects larger than 3 cells

Show a white left hand diagonal in each cell in intensity alarm

Show a blue horizontal line in each cell in color alarm as a result of green/blue variation

Show a green vertical line in each cell in color alarm as a result of red/green variation

This diagnostic information is extremely useful to the implementers during analyzer testing and to the end user during system installation and setup.

VCC Video Control Center

The VCC is a software package installed on a PC at the central site. It monitors one or more RVEs to obtain live video, alarm video clips, and alarm event messages that are recorded in a local database.

System Software

The system runs Microsoft Windows XP or Windows 2000 operating system.

The application software uses the Microsoft DirectX/DirectShow video framework. This provides some basic video capability that saves time in the development effort but is not a prerequisite to the implementation.

It also uses a relational database via ODBC (Open DataBase Connectivity—a standard generic method for connecting applications to a variety of relational databases). The current implementation uses Microsoft SQL Server Desktop Edition but (because of the user of the standard ODBC) could easily be adapted to any relational database.

Application Software

Referring to FIG. 13, there is a communications client 190, 192 and a unit controller 194, 196 for each RVE and a video engine 198, 200 for each live camera feed on each RVE.

The VCC application software includes several major modules and sub-modules that are interconnected in various ways. These include an application controller, a control interface, unit controllers (one per RVE), video engines (one per camera per RVE), a diagnostic console, a local web server, a database interface, a communications client (one per RVE), communications I/O drivers, and a system logger.

The application controller 202 runs on startup and creates the web server 204, the control interface 206, the diagnostic console 208, and a unit controller 194, 196 for each RVE. Each unit controller creates a communications client 190, 192 that connects to the I/O driver 212, 214 to be used for that RVE. If a live feed is present then the unit controller also creates a video engine 198, 200 for each camera on that RVE. Each communications controller monitors its RVE for events, alarm video clips, and live feed data, which is dispatched as needed to the database 210 or the video engines.

The user can set a variety of parameters that control the overall operation of the system. The parameters may include those listed here although it will be necessary to understand the various system components (discussed later) in order to fully understand them.

UnitList—the user provides a list of the RVEs to be monitored.

WebPort—this is the TCP port to be used by the HTTP portion of the local web server (discussed below).

OCXPort—this is the TCP port to be used by the streaming video portion of the local web server (discussed below).

AutoDelete—this indicates how many days old files should be kept. These include DVR files, alarm files and log files.

FileHours—indicates how long each DVR (digital video recorder) file should be.

Additional information about each RVE can also be specified and is described below.

I/O Driver/Setup—selects which driver to use (DF1, TCP, SIO) and provides setup information specific to that driver (port, channel, baud rate, node address, timeout values, etc).

InterMessage Delay—specifies the amount if time (if any) that the VCC should wait between each message to the RVE. This allows some control of the load that the VCC imposes on the shared plant network.

DVR Enable—enables/disables the high resolution DVR function.

Monitor Enable—enables/disables the diagnostic video monitor function. The operation of each component is described in detail below.

Application Controller.

The application control module 202 handles the main startup and shutdown of the application. It coordinates the connection and operation of the other components. This includes initial loading of the application configuration parameters, configuration and starting the other components according to those parameters, and monitoring for user requested configuration changes.

In particular, it creates the control interface, the local web server and a unit controller module for each RVE to be monitored.

Control Interface

The VCC exposes a ‘Command and Control’ interface that allows external applications (in particular the UI server) to access the VCC. In particular this includes a streaming video server to which the UI server will connect end users who chose to monitor the live video feed and a command interpreter that can accept commands to control the VCC. These include commands to create, delete and reload configuration information for the RVEs. This interface is in the form of a TCP socket. Many of these commands are the same ones that can be issued from the diagnostic console or from web pages served by the local web server. See the local web server discussion below for more information.

Unit Controller.

There is a unit controller for each RVE that the VCC has been configured to monitor.

The purpose of each unit controller is to create and coordinate the operation of several subtasks involved in managing an RVE. Together with its helper tasks it must: establish and monitor a connection with the RVE; upload events, alarm clips and optional live video from the RVE; and monitor user requests for configuration changes to the RVE and download new configurations as needed.

The unit controller must isolate the modules making requests (e.g., the UI server making requests via the control interface) from the potential delays involved in communicating over a shared low bandwidth network to the RVE (which coincidentally might be offline). The user interface needs to remain responsive and be able to perform other tasks while these time-consuming requests are completed.

The unit controller first creates a communications client (see below) to monitor the RVE and to upload event, alarm and video data. The unit controller must then wait for the communications client to obtain certain configuration data from the RVE before it can proceed. This includes the camera count and the compression parameters.

Once this data is obtained the unit controller creates a video engine for each camera.

Communications Client.

The system is designed for a ‘polling’ environment in which the VCC is the master (client) and the RVE is the slave (server).

The communications logic of the VCC is in two layers. Most of the logic is independent of the actual transport (TCP, DF1, MODBUS, etc) and is contained in the communications client task (described here). Some of the logic is specific to the network and protocol in use and is described in the I/O driver section.

The communications client initially obtains basic configuration and status information from the RVE including the camera count and video compression parameters. Then it polls the RVE for data while monitoring for user requests for upload, download and other system requests (see below).

Remote Unit Polling

The polling logic uses the messages described earlier in the RVE discussion. Each message transaction includes a request sent by the VCC and a reply sent by the RVE. The polling logic operates as follows:

Query available data (events, alarm clips, live video).

If there are events, fetch them and enter them into the database (see database interface discussion)

If there are alarm video clips available, upload them and enter them into the database. As mentioned in the RVE discussion the alarm clip arrives in a compact file that contains the sequence of compressed frames produced by the encoder. This must be converted to a conventional AVI file that can be viewed by the end user.

If there are live video frames available for one or more cameras, and if there is any software enabled in the VCC that requires this live video feed then upload the frames.

The logic used to upload the video frames includes the following features.

First the VCC includes logic to determine if there are any tasks active which require the live feed. This is referred to as the ‘On Demand’ feature of the VCC. These include:

Monitor windows in the UI (either UI server web pages, local web server pages or the diagnostic window in the video engine).

VCC level DVR function—The user can optionally request that the VCC make a continuous recording of the low resolution live video feed.

If any if these live feed consumer tasks are active then the communications task will upload live feed frames from the RVE. Otherwise it will not upload these frames even if they are available. When active, the live feed stream consumes a large part of the available network bandwidth so conserving this resource in low bandwidth applications is critical.

The logic here uses sequence numbers to carefully monitor the stream of frames from the RVE to insure that no I frames are lost. On startup or any time an I frame is lost due to a communications error then the next request for video frame data to the remote will include a flag indicating that a K frame is required. This will cause the RVE to discard all I frames until the next K frame is available so as not to waste valuable network bandwidth on useless data. If the compression algorithm supports it, the RVE will instruct the compression algorithm to immediately deliver a K frame. If not, then it will wait for the algorithm to deliver a K frame before sending data to the VCC.

An additional issue is that the network protocol may support limited message sizes. As a result, it may take several transactions to deliver a single frame. The logic must also use the sequence numbers to insure that all of the data for each individual frame is delivered and reassembled correctly. The polling logic will retry any data that is missed and if it cannot be recovered then it will resume requesting a K frame.

Once a useful frame has been assembled it is delivered via a shared buffer (the RECEIVE BUFFER) to the video source component of the video engine (as described below.)

Client Request Monitor

As mentioned earlier the system may request file upload or download requests as well as other commands (including system restart, camera pan/tilt/zoom, etc). The client request monitor portion of the communications client handles these requests and shares the communications connection with the polling logic discussed above.

Other system components (e.g. the user interface) can make requests by placing them in the client monitor request mailbox. The monitor will service the requests and provide a status back to the mailbox. The system components can monitor the mailbox while performing other tasks.

The client request monitor uses the messages described earlier in the RVE discussion. Each message transaction includes a request sent by the VCC and a reply sent by the RVE.

Video Engine

This component runs if there is a live video feed available from the RVE and there is an active user of the live feed on the VCC. It is a software system based on the Microsoft DirectShow framework. It acquires and processes the video data provided by the remote (RVE) and routes it to the various other sub-components within the VCC.

Following the flow of video data thru the processing logic aids in the description of the operation of this component and its internal sub-components. The specific connections between sub-components described below represent a good balance between flexibility and performance. Other permutations of the sub-components are possible.

There is a separate VCC video engine running for each camera in each RVE. Each engine allows the user to select a variety of options to optimize performance for his application.

Common Video Source

The purpose of the common video source is to provide the compressed frames to a variety of components (see below) within the video engine for further processing.

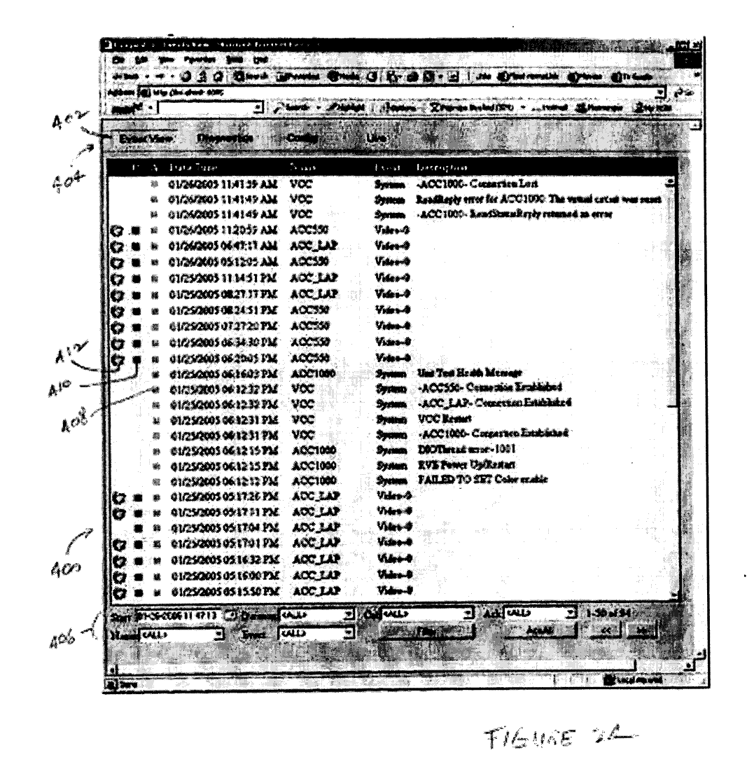

As shown in FIG. 14, the communications client 228 (described elsewhere) reads compressed frames from the RVE using the 1/O driver 230 and delivers them to a receive buffer 232 where the capture filter 234 recreates the stream in Microsoft DirectShow format.

The compressed frame stream from the capture filter output is delivered to a splitter 236. This splitter module delivers the same stream to multiple internal processing streams 238. These include the DVR stream, the local web stream and (optionally) a simple on screen monitor window that is part of the diagnostics console used for testing. Each of these continuing streams is described below. These streams can each be enabled or disabled under software control as needed for a particular installation.

DVR Stream

As shown in FIG. 15, the stream of compressed frames is delivered from the splitter 240 output to a file writer module 242 that stores them in a conventional AVI format in a disk file. Because of their format, AVI files are not viewable until they are complete and closed. The user can select how often the files should be closed (e.g., once per hour). A new file is opened (started) each time the previous file is closed. If necessary, the user can force the current files to be closed immediately (for example if a file that is not scheduled to be closed for some period of time needs to be reviewed immediately in an emergency). A new file will immediately be started.

Local Web Stream

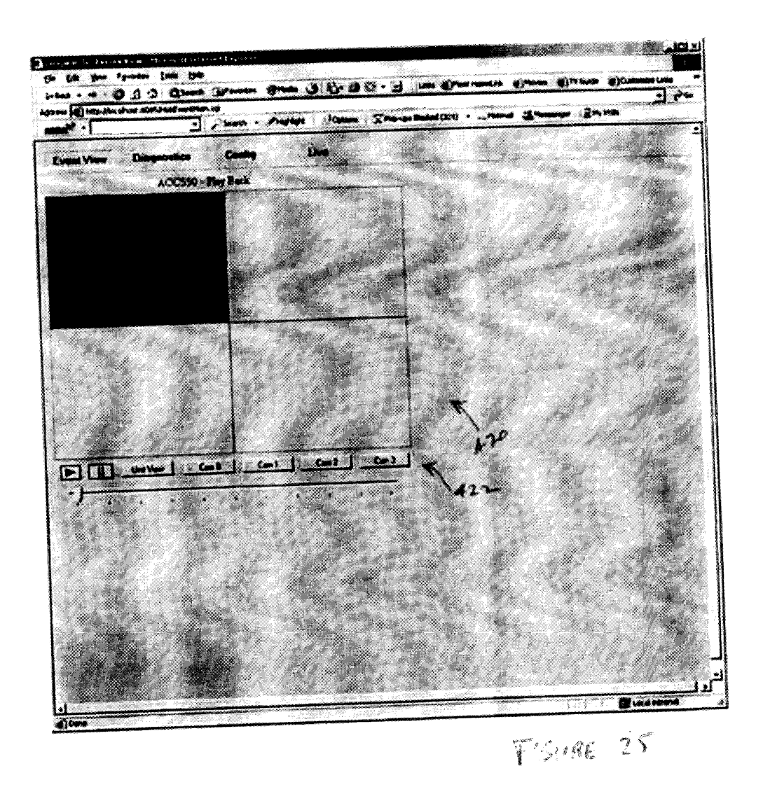

As shown in FIG. 16, the stream of compressed frames is delivered from the splitter output to a video decompression module 244.

The decompression module is the inverse of the compression module in the RVE and uses the Microsoft Windows Media 9 compression algorithm. It converts the series of compressed input frames to a series of bitmap output frames.

The bitmap stream is delivered from the compressor output to the RGB render module 246. The RGB render module stores the bitmap in a shared memory area called the RGB buffer 248 from which it can be fetched by the streaming video server.

Diagnostic Console Stream

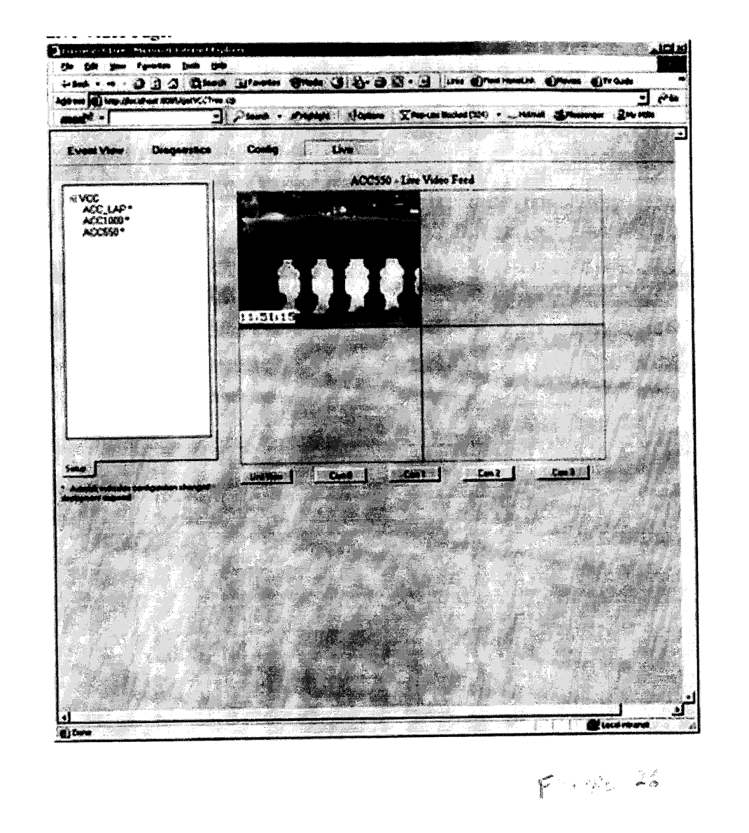

As shown in FIG. 17, the diagnostic console stream provides live video on a monitor attached to the general purpose PC on which the VCC software is running. This is used primarily for testing since in general the user will view the video using the web or Active/X control interfaces.

When enabled, the stream of compressed frames is delivered from the splitter output to a video decompression module 250 that converts the series of compressed input frames to a series of bitmap output frames; the bitmap stream.

The bitmap stream is delivered from the compression module output to the video render module 252. The video render module (which is a part of the Microsoft DirectShow Framework) writes the bitmap directly into a window on the video screen of the monitor.

I/O Drivers

The I/O driver layer includes a module for each supported communications protocol. These may include TCP (for connection to high speed networks), DF1 (for connection to Allen Bradley's industrial network) and SIO (for generic connections to devices using a serial communications method.)

Each I/O driver handles and routes application layer messages that relate specifically to communications between the VCC and RVE. In general it does this as follows;

Request access to the driver (which may be shared by several unit controllers)

Perform the transaction (send the message, read the reply)

Release the driver for use by other unit controllers.

It is responsible for opening and closing a connection to the network and sending and reading data packets for the network.

The specific commands supported by each driver include the following. (The actual implementation of each command will vary as needed for each driver.)

Init—to which the unique address of the RVE is specified along with any needed communications parameters.

Connect—is called to open a connection to the RVE or to restore a lost connection following an error

StartTransaction—is called to indicate the start of a send/read transaction in case the driver contains lower level shared components that must be reserved or locked.

SendRequest—is called to send an application message request to the RVE.

ReadReply—is called to read an application message reply from the RVE.

EndTransaction—is called to indicate the completion of a transaction so that other tasks may use the driver.

Close—is called on shutdown to end the connection with the RVE.

Local Web Server

Like the RVE web server the VCC web server includes two main components:

One is a conventional HTTP server. It serves pages that are created using conventional HTML. These pages can be static or can be dynamically generated using a function similar to conventional CGI scripts or ISAPI add-ins and can also include dynamic server side substitution of values within the HTML. Such techniques are in common use.

The HTTP portion of the local web server in the VCC is intended for use primarily during system test. It is generally not used by the end user. The end user will use the web server provided by the UI server application (described later). The VCC web server allows the programmer to access configuration and diagnostic information in the VCC for testing purposes.

The second component is a streaming video server. This is designed for use with a specially written video player control that runs as an object in the web page. A single TCP socket is used to connect the streaming server to the video player object. The socket can be used in two modes: command mode or streaming video mode. In command mode the client can send commands or requests to the server using an extensible protocol and get replies. If the client requests the socket be put in streaming video mode then the outbound side of the socket includes a series of video frames that are obtained from the RGB buffer module described above. In that case, the only command the client can send is to stop the stream and place the socket back in command mode.

Note that the streaming video server may be accessed by any web page—not just by pages provided by the VCC web server. In particular, the ‘Live Video’ pages provided by the UI server (see below) contain video player controls that are linked to this VCC Server.

Database Interface.

The database interface in the VCC provides two functions. It reads the configuration information from the database at startup or when a configuration change has been made using the UI. And it also allows the VCC to make entries in the event database. These events may originate within the VCC itself or may be sent by the RVEs to the VCC for entry into the database.

Events from the VCC include:

Software errors in the VCC system software

Communications events (communications lost or established to a RVE)

Events from the RVE (remotes) include:

Software errors in the RVE system software

System restart (including restart with new configuration)

Alarms (digital inputs or video sensing)

Alarm clips (AVI files capturing an alarm event)

A key feature of the database design is the ability to associate multiple alarm video clips with an event. As noted earlier each alarm event (either a hardware digital input or image analyzer virtual input) has a unique ID assigned and can also trigger the generation of video alarm clips for any combination of cameras. Those video clips are all linked via the database to that unique Alarm ID. This allows the user interface to simultaneously show the operator the clips from all of the cameras.

The database is a conventional relational database.

Diagnostic Console

The VCC diagnostic console is intended primarily for use in testing the software. It is generally not used by the end user. When enabled, it runs as a text window on the video monitor attached to the general purpose PC and monitors input from the PC keyboard. It shows a diagnostic trace of the operation of the system. Different levels of trace can be enabled using different key combinations. Also various system operations such as restart as well as alarm triggers and even system errors such as communications errors can be simulated from the keyboard. This allows the system designers to more easily and completely test the system operation.

System Logger

The VCC system logger is used primarily for diagnostics. Various parts of the system send messages to the logger about operations being performed. Each message is flagged as ERROR, INFORMATIONAL or DEBUG. The logger routes the messages to (a) the diagnostics console where they are printed in a window on the video monitor (and can be filtered according to importance) (b) the event message list in the database (in the case of ERROR messages) and optionally (c) a text file on disk. The disk file is closed every hour and deleted after specified number of days so as to limit the space consumed. The files can be examined as needed to help diagnose problems with the system.

UI Server

As shown in FIG. 18, the UI server 260 is a typical Web/Internet/Intranet server. It provides pages that allow the user to configure and control the system and to view events and video clips using one or more Internet browsers 264. Data to populate the configuration and event pages is obtained from the relational database 266 mentioned earlier. As mentioned earlier these pages can also be displayed in existing ‘browser controls’ that can then be embedded in existing user applications such as HMI displays

Configuration

The configuration parameters viewed and entered by the user in those pages were also discussed earlier. The browser pages allow configuration of the VCC (Video Control Center) and also the RVEs (Remote Video Engines).

Note that when RVE units are added or deleted, the UI server sends command and control messages to the VCC using the interface described earlier to cause the VCC to revise and/or reload its configuration.

FIGS. 28 through 30 show features of the user interface browser pages that enable the user to set the configuration parameters for the VCC (configuration of the RVEs will be discussed later). The interface is organized using two tab-style controls 380, 382. One control 380 has three tabs. When the setup tab 383 is invoked, the other control 382 displays parameters that can be changed by the user, then saved, and deployed. The unit being configured is determined in the setup tab by selecting the unit (the VCC is selected and highlighted in the example of FIG. 28.)

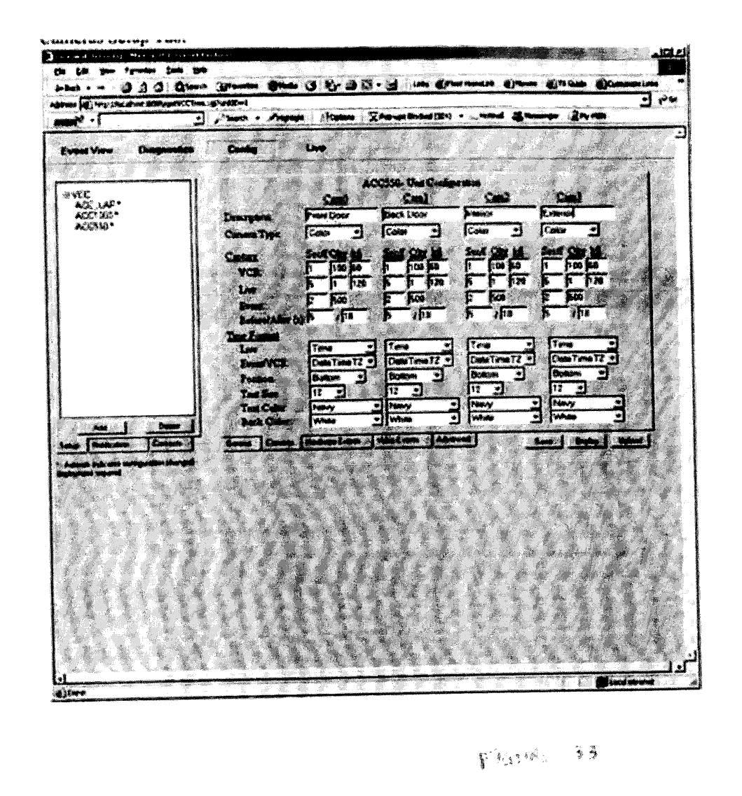

As shown in FIG. 29, when tab 385, called Contacts, is invoked, a hierarchical list of contacts 386 is shown and the name and email address of a user account can be seen and set in control 382. New contacts may be added, just as new units can be added in the page of FIG. 28.

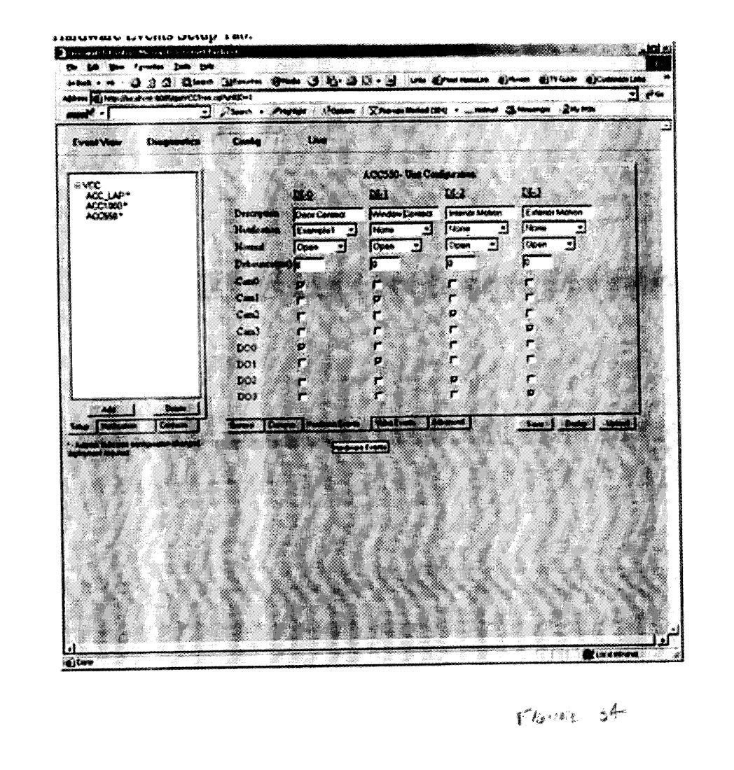

Notification parameters can be set when the notifications tab 387 is invoked, as shown in FIG. 30. In FIG. 30, the ISP accounts used for communication of the notifications are set. As shown in FIG. 31, when an example of a scheme appears in the hierarchy, the user may enter or modify parameters as shown.

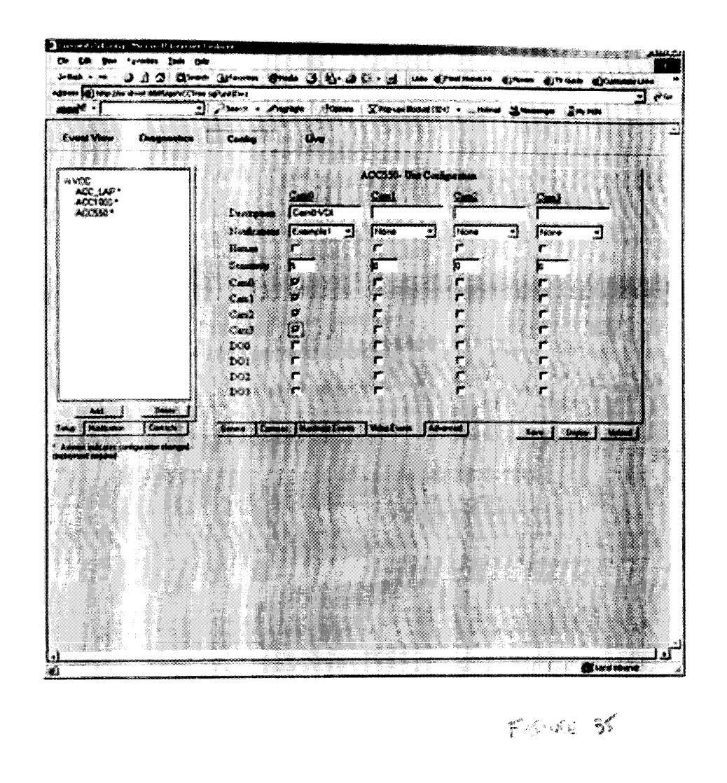

FIGS. 32 through 36 illustrate setup parameters that can be entered and modified by a user with respect to RVE units that lie under the VCC in the hierarchy. In this example the RVE units are given names such as ACC1000, ACC550 and ACC_LAP although virtually any name can be used. When an RVE is invoked in the hierarchy, the tabs of control 382 change to include five tabs that are illustrated in FIGS. 32 through 35.

Thus, it should be apparent that the system allows the user to easily edit and deploy configuration parameters for the equipment at the remote location using an online user interface. The system can detect any mismatch between the configuration parameters stored in the database at the central location and configuration parameters being used at the remote site. Configuration parameters are sent between the central location and the remote location using the PLC network and the PLC communication protocol.

Operator Runtime

As shown in FIG. 24, a primary runtime display is an events page 400. The events page is selected by clicking on the Event View button 402 in the button bar 404. Each row of the page shows, for an event, the date and time, the name of the system element involved in the event (e.g., VCC or ACC_LAP), the type of event (e.g., Video-0), and, in some cases, a comment on the event (e.g., ReadReply error for ACC1000 . . . ).

The events included in the events page can be selected and navigated using buttons and boxes 406 at the bottom of the page. The user may enter a start time, a duration, a category, a name, or an event type, and whether the event was acknowledged, and in that way choose the events that will be displayed. The user can also scroll up and down within the page or navigate from page to page to view all selected events, in the usual way. This allows the end user to query the relational database and view events based on a variety of filters. Such techniques are in common use.

Some events have a red block 410 displayed in the second column (labeled ‘C’) to indicate that a security related alarm has occurred (as distinguished from a simple maintenance event). These events will generally have one or more alarm video clips (as described earlier) associated with them. The third column (labeled ‘A’) indicates if the alarm has been acknowledged. It shows a yellow square 408 for unacknowledged alarms and changes to a black check mark for acknowledged alarms. The user can, in some implementations, acknowledge an alarm by (a) clicking the yellow rectangle or (b) replying to an email sent by the notifier or (c) clicking the Ack All button (which will acknowledge all alarms on the page). Other forms of acknowledgement may also be implemented.

An icon 412 in the first column of the event display indicates the presence of such a clip. Clicking on this icon will present a page (shown in FIG. 25) in which all of the alarm video clips for that event are loaded and played in four separate windows 420 in the user's browser. This allows the user to view the event from several different angles. Controls 422 under the viewing windows permit the user to span all four viewing windows using a single clip, to choose which camera clip to view, and to navigate temporally through each of the clips.

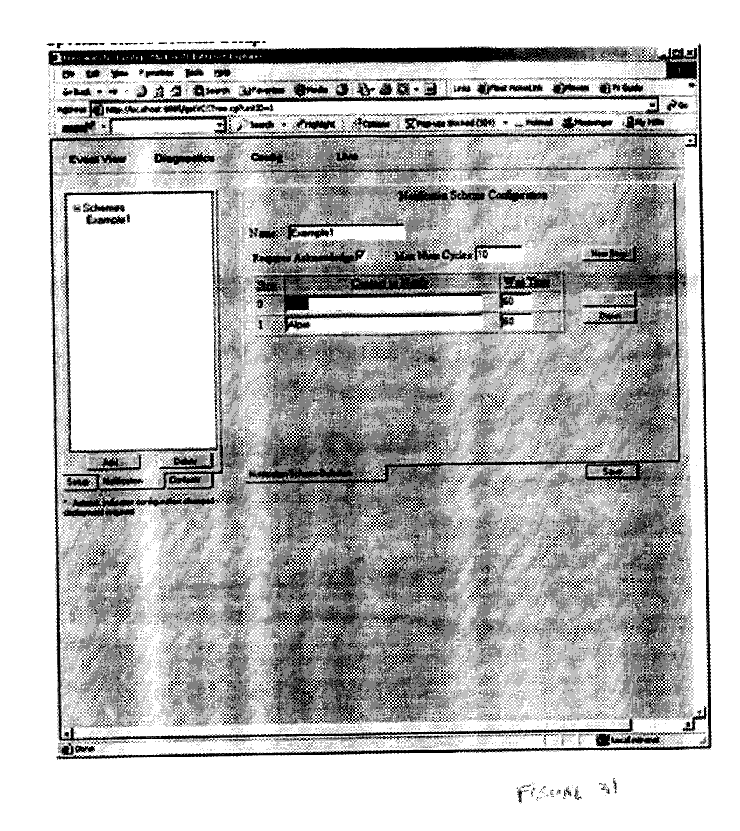

As noted earlier the alarm video clips are stored as AVI files. As shown in FIG. 26, by clicking on the Live button 420 of the button bar, the user can view the low resolution live feed 422 from the RVEs in his browser. To do this the server generates a web page containing a special video player (as described below) and provides links within the page that connect that player to the appropriate streaming video server that is part of the VCC (as described earlier). On the left side of the page is a box 424 that shows, hierarchically in terms of the units of the system, the source of the live feed.

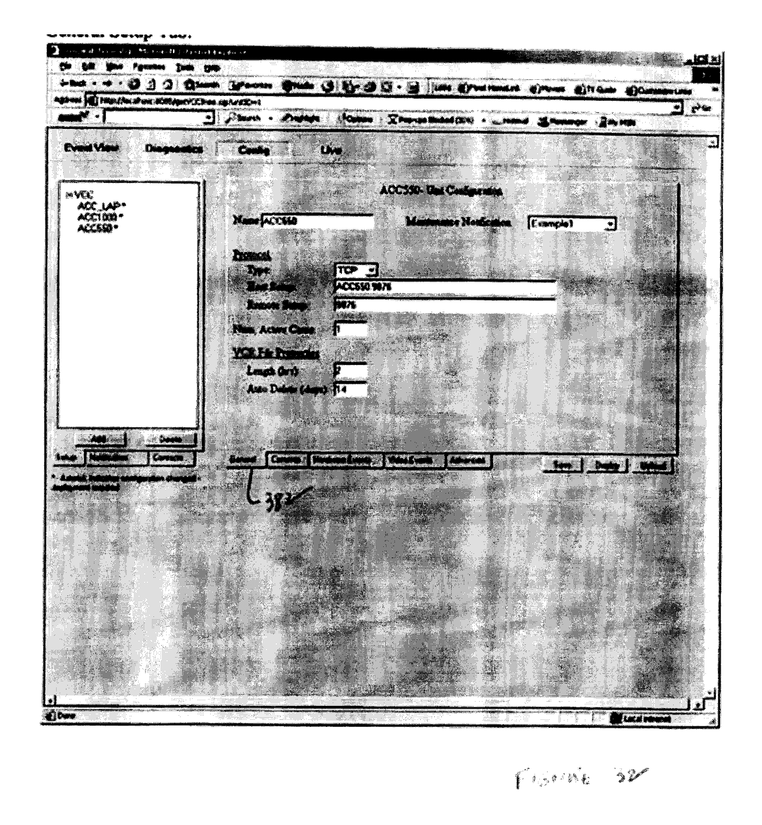

A diagnostics page 430 (FIG. 27) can be invoked using the diagnostics button 432. For each unit of the system a line of the display 434 identifies the unit, its communications status, the result (success or fail) of the most recent command sent to the unit, an indication of whether or not the most recent configuration changes have been downloaded to the unit, the time of the last received status information, the number of messages received from the unit, the number of times the communications system has had to reconnect to that unit and the percentage of any outstanding download (e.g. of a new configuration) or upload (e.g. of an alarm video clip) completed. These are only a few of the many status and diagnostic parameters that could be displayed.

Video Player Object

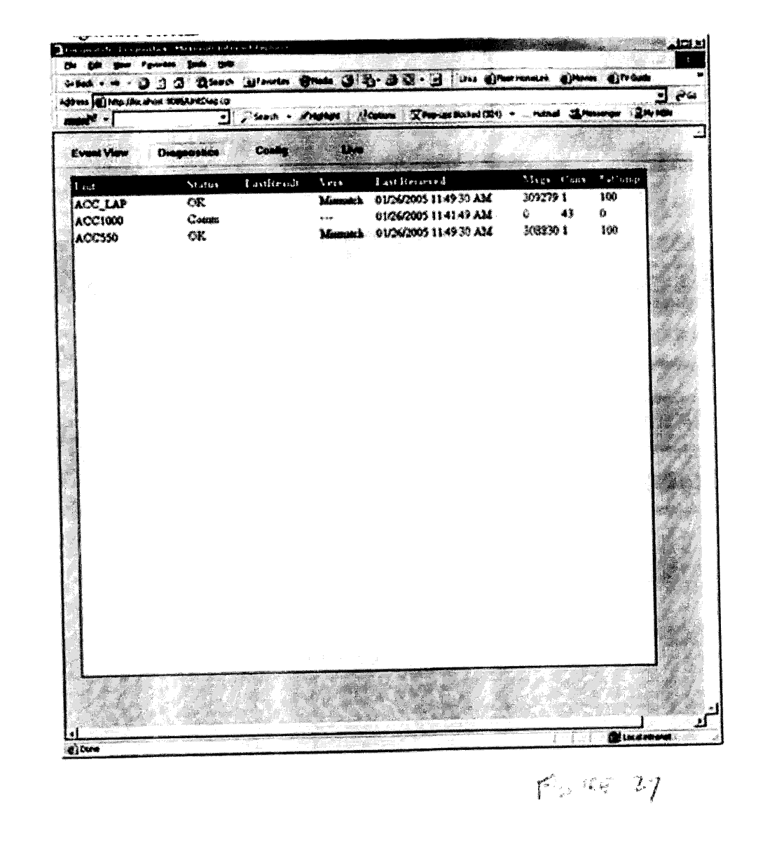

As shown in FIG. 19, the video player object 266 is used by the web pages 268 that are provided by the UI server 270 and also the local web servers of the RVE and VCC 272. If the video player object is not already present on the machine displaying the web page then it is downloaded automatically from the UI server or local web server using standard Microsoft techniques (specifically an INF file).

The video player operates in two modes.

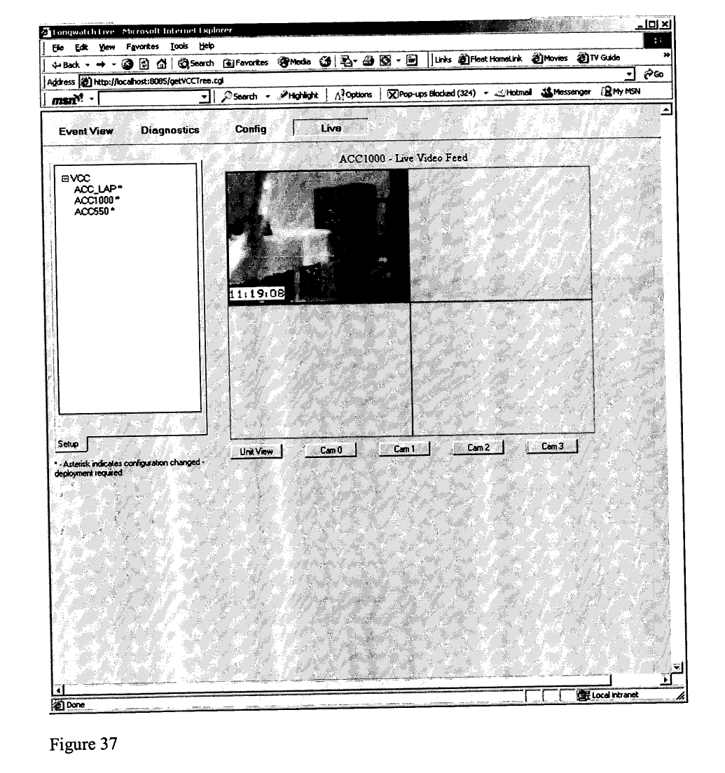

In LIVE mode the video player establishes a TCP channel to the streaming video server. The address of the video server and the ID of the RGB buffer from which to fetch the data is embedded in the web page. The streaming video server does not necessarily need to be the same software process or even reside on the same computer as the web server that provides the web page. (Having separate servers for web pages and video streams is a commonly used technique). The player then reads images over the TCP socket and uses conventional Windows Graphics commands to write them to the screen. A feature of live mode is that the image includes a flag indicating if the data is older than a specified limit. If so then a visual indication is added to the image to warn the operator that the data is ‘last good data’ but not necessarily current. In the example of FIG. 37, a red box is displayed at the perimeter to indicate the last good data.

In Playback mode it reads an AVI file from the web server using a conventional HTTP GET request. The AVI file is then played used a conventional Microsoft DirectShow Filtergraph.

Notification Manager

The notification manager is a program that periodically queries the relational database to determine if there are outstanding alarms that have not been acknowledged by the user. If there are it will send email notifications to one or more destinations based on a user provided set of rules.

These rules allow the user to specify a sequence of individuals to notify in a specified order and with specified delay. The notification process can be terminated as soon as one individual responds to (acknowledges) the notification.

A wide variety of other implementations are also within the scope of the claims.

The bandwidth of the communication channel may be, for example, having a rate up to 56K bits per second or 100K or 256K. Higher bandwidth channels (including broadband channels) may also be used.

For example, although the discussion has emphasized processing of video data, still image data, audio data, and other kinds of data may be processed locally, communicated to a central station, and used for surveillance purposes.

The system may be used in surveillance in a wide variety of remote site and equipment management applications in addition to water supply and wastewater applications, including schools, industrial facilities, natural base delivery systems (using, e.g., SCADA), and military operations, including (but not limited to) any location or operation that is served by a low-bandwidth communication channel and has a network that conforms to a programmable logic controller communication interface, whether proprietary or publicly available. Other examples include oil transmission, natural gas transmission, on-line water quality monitoring equipment vendors natural gas local distribution companies (ldc's), electric power distribution, distributed generation municipalities, distributed systems services, infrastructure security, compressor leasing services, vending industry, passenger rail systems, high risk areas, freight lines, commuter rail, department of transportation, municipal/police, bridges/highway.

A wide variety of other implementations are possible, using dedicated or general purpose hardware, software, firmware, and combinations of them, public domain or proprietary operating systems and software platforms, and public domain or proprietary network and communication facilities.

A wide variety of audio-visual capture devices may be used, not limited to video devices.

The remote location and the central location need not be in separate buildings; the terms remote and central are meant to apply broadly to any two locations that are connected, for example, by a low bandwidth communication network.

User interfaces of all types may be used as well, including interfaces on desktop, laptop, notebook, and handheld platforms, among others. The system may be directly integrated into other proprietary or public domain control, monitoring, and reporting systems, including, for example, the Intellution-brand or Wonderware brand or other human machine interface using available drivers and PLC protocols.

1. A method comprising
at a remote location, receiving audio-visual data and processing the audio-visual data to produce processed audio-visual data, and
communicating the processed audio-visual data to a central location using a programmable logic controller communication protocol.

2. The method of claim 1 in which the audio-visual data comprises video data.

3. The method of claim 1 in which communicating the processed audio-visual data comprises communicating non-protocol-compliant data encapsulated in protocol-compliant communications.

4. The method of claim 1 in which the processed audio-visual data is communicated as live audio-visual on demand data.

5. The method of claim 1 in which the processed audio-visual data is communicated as event-based audio-visual data.

6. The method of claim 1 in which the processed audio-visual data is communicated as continuous live audio-visual data.

7. The method of claim 1 in which the processed audio-visual data is communicated at a rate that accommodates a bandwidth of a communication channel on which the data is communicated to the central location.

8. The method of claim 1 in which the audio-visual data comprises at least one of audio data, still image data, or video data.

9. The method of claim 1 in which the communication protocol comprises a PLC protocol.

10. The method of claim 9 in which the PLC protocol comprises Modbus or DF1.

11. The method of claim 9 in which the PLC protocol comprises one or more of ROC native, BSAP, and DF1 Radio Modem Protocol, DNP, UCA, IEC-61850, IEC-60870, GESNP, TIway, and Profibus-DP.

12. The method of claim 1 also including reporting diagnostics at the central location.

13. The method of claim 1 in which the communicating is at a bit rate lower than 56K bits per second.

14. A method comprising
at a central location, receiving communications of processed audio-visual data generated at a remote location,
the communications being received on a low-bandwidth communication channel using a programmable logic controller communication protocol.

15. A method for use with a water supply or wastewater system, comprising
producing video data for a field of view in a vicinity of at least a portion of the water supply or wastewater system,
processing the video data to produce processed audio-visual data,
communicating the processed video data to a central location using a low-bandwidth communication channel in accordance with a programmable logic controller communication protocol, and
making at least a portion of the video data available to a user for monitoring the water supply or wastewater system.

16. A method comprising
at a remote location, receiving audio-visual data from an audio-visual capture device and using a local processor to process the audio-visual data to produce processed audio-visual data, and
communicating the processed audio-visual data to a central processor at a central location using a communication channel,
the rate at which the processed audio-visual data is communicated being selectable to accommodate characteristics of the communication channel.

17. An apparatus comprising
a local processor,
one or more input ports to receive an input audio-visual data signal to be processed by the local processor,
one or more ports to communicate processed audio-visual data and control information to a central processor located remotely from the local processor, and
stored instructions to cause the local processor to act as a programmable logic controller with respect to communication with the central processor.

18. The apparatus of claim 17 in which the processed audio-visual data is communicated on a low-bandwidth communication channel that is part of a low speed plant network.

19. The apparatus of claim 17 also including an audio-visual capture device to produce the input audio-visual data signal.

20. A method comprising
at a remote location, receiving audio-visual data,
identifying an event at the remote location,
storing a brief segment of the audio-visual data associated with the event, including audio-visual data that was received prior to the event, and
communicating the brief segment of the audio-visual data to a central processor at a central location.

21. The method of claim 1 also including
communicating commands from the central location to the remote location with respect to the processed audio-visual data.

22. The method of claim 21 in which commands control the communicating of the processed audio-visual data to the central location.

23. The method of claim 21 in which the commands control an audio-visual capture device at the remote location.

24. The method of claim 23 in which the commands control a video camera to pan, tilt, or zoom.

25. The method of claim 1 also including
at the remote location, determining an event condition

26. The method of claim 25 in which the event condition is based on the audio-visual data.

27. The method of claim 25 in which the event condition is based on signals from intrusion detection devices.

28. The method of claim 25 in which the event condition is based on a command determined by software at the central location.

29. The method of claim 25 in which the event condition is based on analysis of images represented by the data.

30. The method of claim 25 in which an alarm is triggered based on the event condition.

31. The method of claim 1 also including
analyzing characteristics of at least one image of a field of view at the remote location represented by the audio-visual data, and
determining the alarm condition based on the audio-visual data and the analyzing.

32. The method of claim 31 in which the analyzing includes color information.

33. The method of claim 31 in which the analyzing includes intensity information.

34. The method of claim 21 in which the commands comprise audio-visual parameters that are communicated in conformity with a programmable logic controller communication protocol.

35. The method of claim 1 in which the processed audio-visual data can be a selected one or more of high quality video files, medium quality event clips, and low quality streaming video.

36. The method of claim 1 in which the remote location comprises a location of a water or wastewater system.

37. The method of claim 1 in which the remote location comprises a location of a natural gas SCADA network.

38. The method of claim 1 in which the remote location comprises a location of a distributed monitoring and control network.

39. The method of claim 1 also including providing the processed audio-visual data as part of a graphical user interface.

40. The method of claim 39 in which the processed audio-visual data is converted to AVI format for use in the graphical user interface.

41. A method comprising
at a remote location, receiving audio-visual data,
identifying an event at the remote location based on the audio-visual data, and
controlling equipment at the remote location based on the event.

42. The method of claim 1 also including
enabling a user to provide configuration parameters for the remote location using an online user interface.

43. The method of claim 42 in which the configuration parameters are provided to the remote location using the programmable logic controller communication protocol.

44. The method of claim 1 also including
detecting a mismatch between configuration parameters stored in a database at the central location and configuration parameters used at the remote location.
